(19) United States
(12) Patent Application Publication
(10) Pub. No.: US 2026/0158399 A1
(43) Pub. Date: Jun. 11, 2026

(54) SYSTEMS AND METHODS FOR REPLAYING VIDEO AND INTERACTIVE EXPERIENCES

(71) Applicant: Adeia Guides Inc., San Jose, CA (US)

(72) Inventors: Dhananjay Lal, Englewood, CO (US); Aldis Sipolins, Somerville, MA (US); Jean-Yves Couleaud, Mission Viejo, CA (US); Charles Dasher, Lawrenceville, GA (US)

(21) Appl. No.: 18/972,553

(22) Filed: Dec. 6, 2024

(51) Int. Cl. A63F 13/86; A63F 13/35; H04N 21/2187; H04N 21/234; H04N 21/4223; H04N 21/443; H04N 21/8358; H04N 21/858

(52) U.S. Cl. CPC A63F 13/86; A63F 13/35; H04N 21/2187; H04N 21/23418; H04N 21/4223; H04N 21/4437; H04N 21/8358; H04N 21/8586

(57) ABSTRACT

Systems and methods are described for enabling a device of a user to capture a presentation of video media content and to participate in an interactive experience with the video media content being presented. The disclosed methods may use a first device to capture video frames associated with the presentation of video media content via a second device. Identifying information associated with the captured frames is provided to a content recognition server, which determines a content ID and a game state of the video media content at the time it was captured. A URL corresponding to the content ID and game state is generated and provided to the user. Based on a user-interface interaction with the URL, the user may participate in an interactive experience with the video media content, for example, by being added to a virtual machine for a video game session related to the presented content.

### FIELD OF DISCLOSURE

The present disclosure relates to facilitating interactive experiences with video media content. More specifically, the present disclosure relates to using a device of a user to “catch and replay” an experience presented via the device of the user or a different device.

### SUMMARY

Video media content is consumed by a user in a variety of ways, such as in the form of advertisements, short-form content, long-form content, and media streams, among others. The video media content may be presented via devices such as televisions (TVs), tablets, mobile devices, etc. In some cases, a user's experience with a presentation of video media content may be particularly memorable or remarkable. In such a case, the user may desire to consume the video media content again or continue watching the presentation of the video media content from the position where the user left off. Thus, there exists a need to enable a user to “catch and replay” video media content experiences on their personal devices.

In some approaches, a media content provider facilitates user interactions with media content by providing an advertisement along with the presentation of media content. In some approaches, the advertisement is associated with a QR code that may be scanned using a camera application of a user's personal device. Interacting with the QR code causes the video advertisement to be re-launched on the user's personal device, or the related product associated with the advertisement may be received. In some approaches, this process is accomplished by providing a uniform resource locator (URL) that the user may launch on a personal device. However, the placement of a QR code consumes significant visual space on a display device and the advertisement is shrunk down from its maximum possible display size in order to accommodate the visual space taken by the QR code.

In other approaches, media content providers of long-form content, such as Netflix™ allow a user to log in to the platform. The viewing state of the user (i.e., the point up to which they consumed the content) is saved when the user pauses/stops consuming the content. In some approaches, the user is shown their viewing progress via a progress bar associated with the media content and they are provided with an option to resume the content on any device where they are logged in to the platform. In some approaches, the viewing progress of the user is saved in cloud storage. Similarly, in some approaches, a media content platform such as YouTube™ provides a “Continue Watching” feature that makes it easier for a user to, for example, finish watching a video on a desktop when the video was initially started on a smartphone. In some approaches, other media content platforms teach a bookmarking method that includes saving thumbnail images from a received broadcast video stream, such that the stream may be played from the position depicted in the thumbnail. However, one issue that arises from the approaches noted above is that the user is limited to retrieving and replaying only the content that is available from each media content provider or platform. Additionally, the user is required to, for example, be authenticated with YouTube™ on both devices.

Therefore, there exists a need to enable a user to perform a “catch and replay” of video media content without a priori synchronization with a user's account associated with a particular platform or provider, which would greatly enhance its applicability in everyday scenarios. Additionally, the below systems and methods may enable a user to resume watching a video on their personal device that they “catch and replay” from the world at large or from a screen that is not associated with the user. Furthermore, the below systems and methods may relate to livestreaming of video games. In one embodiment, when watching a livestream of another user playing a video game, the user can participate in an interactive gaming experience, such as playing the same video game as they were watching, commencing at a certain checkpoint that was embedded in the captured state. For example, a user may “catch” a livestream of a video game by capturing a video of the livestream using the user's personal device. The user may subsequently be prompted to “replay” game play of the livestream by playing the video game on the user's gaming console, resuming from the point in the livestream that was captured by the user's personal device.

To help address the limitations and problems exhibited by the above approaches, systems and methods are disclosed herein for allowing a user to “capture and replay” video game content. For example, a user may capture, using a camera of a first device associated with the user, at least one frame of a video game generated for display by a second device, which may be any kind of electronic game. In some embodiments, the captured frame of the displayed video game content is associated with identifying information that is embedded in the video game content by a game engine that provides the stream of the video game. In some embodiments, the first device extracts the identifying information from the captured frames. In some embodiments, the identifying information is computed by the first device based at least in part on capturing at least one frame of the video game content. In some embodiments, the identifying information is transmitted to a content recognition server that is configured to determine, from the identifying information, a content ID associated with the video game and a game state depicted in the captured frames of the video game. In some embodiments, based at least in part on the content ID and game state, the content recognition server generates a URL, which is subsequently provided to the first device of the user. In some embodiments, the URL is a user-interactable link. In some embodiments, upon receiving a user-interface interaction with the URL, at least one device of the user is caused to join a video game session of a video game that matches the content ID. In some embodiments, the video game session is configured based on the game state of the video game captured by the first device of the user.

In some embodiments, the identifying information for a livestream of a video game is generated by the game engine. In some embodiments, the identifying information corresponds to a reference point in the livestream of the video game. In some embodiments, each reference point in the livestream of the video game comprises the content ID for the video game and a current game state of the video game. In some embodiments, the identifying information is computed and transmitted to the content recognition server, which provides the identifying information via the presentation of the video game content on the user's devices. In some embodiments, the device of the user is enabled to receive the identifying information corresponding to a reference point in the video game content that is captured by the user device.

In some embodiments, the video game session is depicted in a livestream of a streamer video game session. In some embodiments, the streamer video game session is provided by a virtual machine for the video game. In some embodiments, the content recognition server maintains a data structure comprising a plurality of URLs respectively associated with different game states depicted in the streamer video game session. In some embodiments, the received URL indicates the content ID for the video game and a current game state of the streamer video game session. In some embodiments, the plurality of URLs respectively corresponds to the identifying information associated with the frames of the livestream. In some embodiments, the device of the user joins the user to the streamer video game session by adding the user to the virtual machine for the video game and generating frames of the video game on a display device of the user, based on the content ID and game state indicated by the received URL. For example, if there is room in the gaming server for the user, the user may begin playing the video game with their favorite streamer.

In some embodiments, the device of the user is not eligible to be added to the same virtual machine providing the streamer video game session. In this case, a new virtual machine for the video game may be generated by a game play server for the device of the user. The new virtual machine for the video game may be configured to correspond to the content ID and game state associated with the generated URL for the streamer video game session. In some embodiments, the user is added to the new virtual machine for the video game. In some embodiments, the user is added to the new virtual machine for the video game along with other devices associated with other users that also interacted with the generated URL. For example, if the user is not eligible to join the same game session as the streamer, the user may be added to a new game session (based on the same parameters as the streamer's game session depicted in the original livestream) with other viewers of the streamer's livestream of the video game.

In some embodiments, the game play server maintains a data structure that contains a mapping of relationships between game states and URLs for a video game. In some embodiments, the game play server updates the data structure by periodically storing new game states in the data structure as game play of the video game progresses. For example, if a livestream of a role-playing game (RPG) video game completes or progresses past a particular quest in the video game, the data structure may be updated with a new game state based on the current progression of the video game. As a further example for an RPG video game, the game state of the video game may contain details such as a most recent checkpoint in the video game, an indication of progress in the video game, and data related to one or more players participating in the video game, among other suitable metrics. In some embodiments, the data structure is shared with the content recognition server, which ultimately provides the URLs to the user in response to receiving a user-interface interaction.

In some embodiments, upon joining the user to a video game session, the video game interface of the user is altered or modified. For example, based on the current game state and the content ID of the virtual machine providing the video game session, the device of the user may transport an in-game avatar of the user to an in-game location depicted by the frames of game play captured by the user's personal device, provide an indicator on an in-game map of the video game that indicates the location depicted by the frames of game play captured by the user's personal device, provide the in-game avatar of the user with certain in-game items that may have been in use when the frames of game play were captured, and/or provide an indication of a progression level of the current game state of the video game.

In some embodiments, it is determined whether the user may be added to the virtual machine associated with a video game session of a streamer. In some embodiments, the device determines a threshold in-game progress level based on an in-game progress level of a streamer hosting the livestream of the video game. In some embodiments, if the in-game progress level of the user does not meet or exceed the threshold in-game progress level, the user will not be added to the virtual machine. For example, the livestream of the video game may depict the streamer playing the video game in Zone 5, the end-game zone of the video game. If the user seeking to join the video game session with the streamer has only progressed to Zone 2 of their personal game session on their own gaming device, the user may not be skilled enough to participate in the video game with the streamer in the end-game zone. In some embodiments, if the user requests to join the same virtual machine providing the streamed game session, but is not eligible, a new virtual machine will be generated. In some embodiments, the new virtual machine comprises the content ID and game state of the streamer game session and provides the user with an interactable preview of the video game session of the streamer. For example, the user may preview playing in Zone 5 by playing as a temporary avatar that mirrors the same abilities, items and/or stats as the streamer of the streamer video game session.

In some embodiments, in response to interacting with the URL for a captured video game session, the user is provided with a user-interface option to generate a list of devices that are capable of executing the video game session. In some embodiments, in response to receiving a user-interface selection of one of the devices in the list, the selected device joins the video game session.

In some embodiments, in response to the user capturing frames of a livestream with their personal device, a video-on-demand (VOD) version of the livestream is generated on the personal device (or another device) of the user. In some embodiments, the user is enabled to resume the VOD version of the livestream from the timepoint that the livestream was captured by the personal device.

In some embodiments, the user is enabled to capture and replay media content using a personal device by detecting an offset of the content from its beginning, so that it can be played on a second screen from the same point at which it was observed by the viewer's personal device on the first screen.

In some embodiments, multiple different users are enabled to join the same game session at the same point as the first user using near field communication (NFC) and by transmitting a join token.

In some embodiments, the system enables players to select sides or teams for multiplayer games by physically being near each other, facilitating a group join that allows multiple players to enter the same game session or server simultaneously.

In some embodiments, once cross-device playback has been initiated, the device providing the original content (e.g., a TV screen) may switch to providing supplemental content related to the original content, which may now be playing on a user's personal device (e.g., a smartphone).

### BRIEF DESCRIPTION OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The embodiments herein may be better understood by referring to the following description in conjunction with the accompanying drawings, in which like reference numerals indicate identical or functionally similar elements, of which:

FIG. 1 depicts an illustrative system for enabling a device of a user to capture a presentation of a video game and enabling another device of the user to join the video game session, in accordance with some embodiments of the disclosure;

FIG. 2 depicts an example data structure configured to store a mapping of game states, URLs and identifying information, in accordance with some embodiments of the disclosure;

FIG. 3 depicts an illustrative process of computing a fingerprint which may include an identification of a video game (e.g., a content ID), in accordance with some embodiments of the disclosure;

FIG. 4 depicts a flow diagram of an example process for enabling a device of a user to capture video media content using identifying information, in accordance with some embodiments of the disclosure;

FIG. 5 depicts a flow diagram of an example process of enabling a device of a user to capture a livestream presentation of video game content using identifying information, in accordance with some embodiments of the disclosure;

FIG. 6 depicts a flow diagram of an example process of enabling a device of a user to capture a livestream presentation of video game content and to join a video game session via a device of the user, in accordance with some embodiments of the disclosure;

FIG. 7 depicts an example user interface embodiment for enabling a device of a user to capture a livestream presentation of video game content and to join a video game session via a device of the user, in accordance with some embodiments of the disclosure;

FIG. 8 depicts an example embodiment of modifying the presentation of video media content on the devices of the user once cross-device playback is initiated, in accordance with some embodiments of the disclosure;

FIG. 9 depicts illustrative devices and systems for capturing and interacting with a presentation of video media content, in accordance with some embodiments of the disclosure;

FIG. 10 depicts devices and systems including a server, a communication network, and computing devices for performing the methods and processes noted herein, in accordance with some embodiments of the disclosure;

FIG. 11 is a flowchart of the process for capturing a presentation of video media content and enabling the user to interact with the video media content, in accordance with some embodiments of the disclosure;

FIG. 12 is a flowchart of the process for adding a user to a virtual machine to join a video game session, in accordance with some embodiments of the disclosure;

FIG. 13 is a flowchart of the process for updating a data structure comprising a mapping of relationships between a plurality of game states and a plurality of URLs for the video game, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

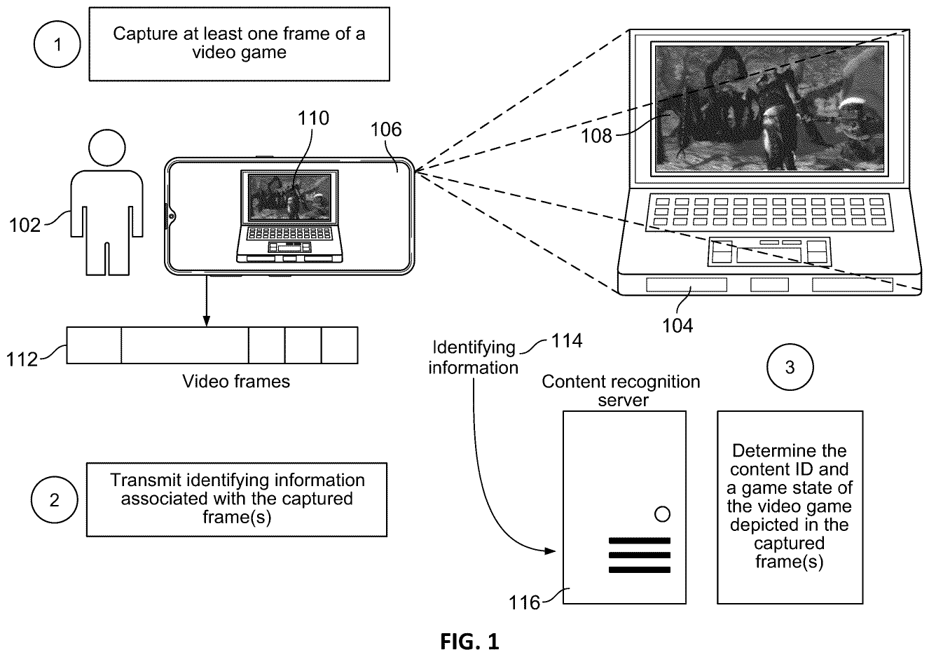

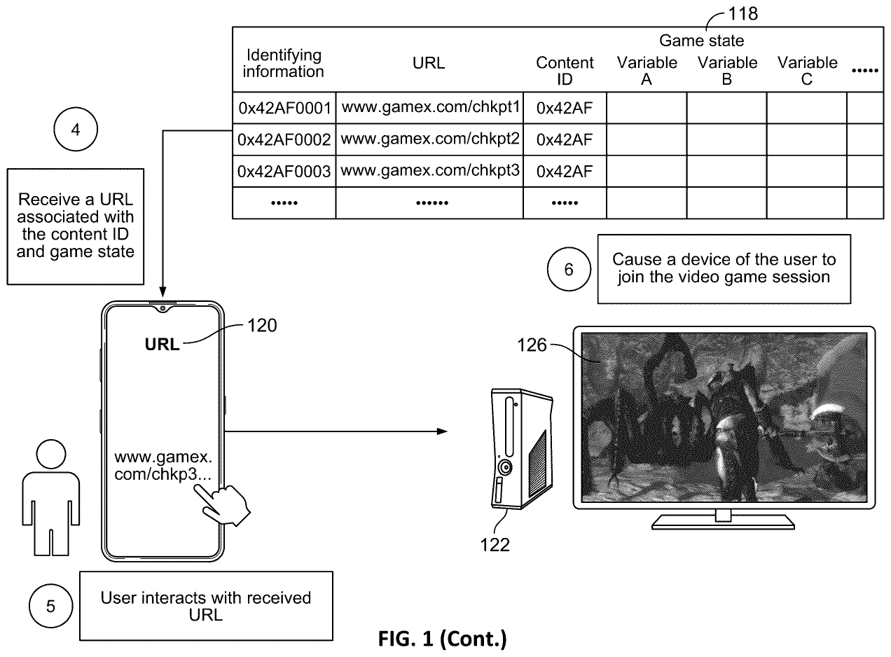

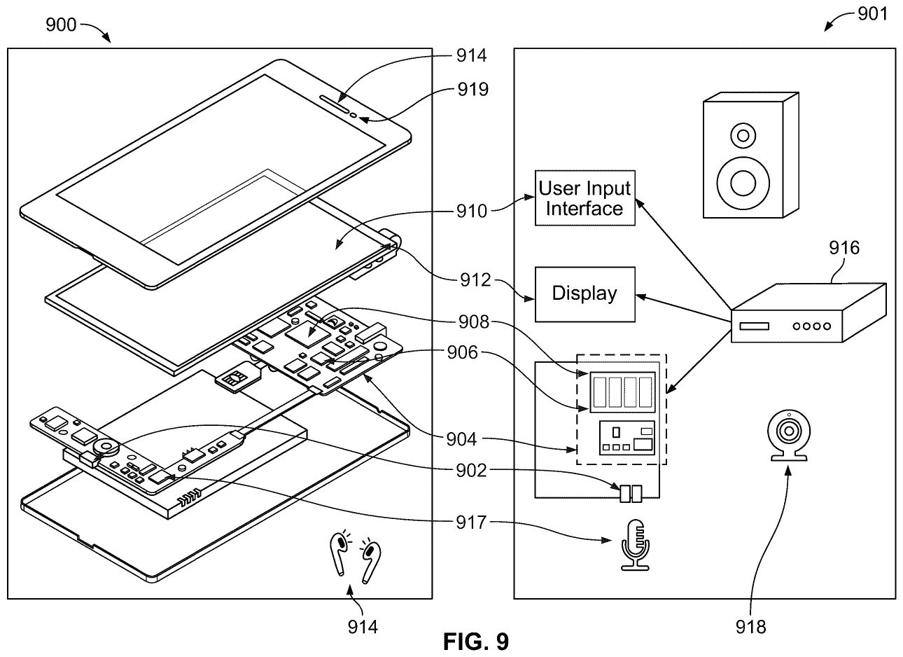

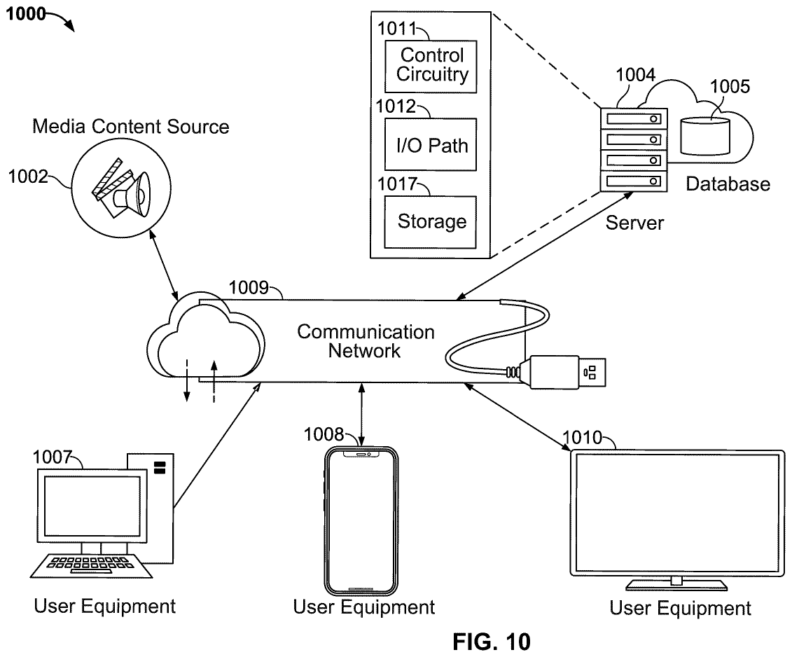

FIG. 1 depicts an illustrative system for enabling a device of a user to capture a presentation of a video game and allowing another device of the user to join the video game session, in accordance with some embodiments of the disclosure. The techniques described herein may be implemented, at least in part, using various devices of a user, such as device 104 and device 106 of FIG. 1. The various devices of a user may correspond to or comprise applications that provide video media content to the devices, which may be executed by the control circuitry of the devices (e.g., control circuitry 904 or 1011, as further described in relation to FIGS. 9 and 10) and/or at one or more remote servers (e.g., server 1004 of FIG. 10 and/or media content source 1002 of FIG. 10), and which may utilize storage devices (e.g., database 1005 of FIG. 10), at or distributed across any of one or more other suitable computing devices, in communication over any number and/or types of networks (e.g., the internet). The applications and various devices of the user may be configured to perform the functionalities (or any suitable portion of the functionalities) described herein. In some embodiments, the applications and/or devices may comprise or employ any suitable number of displays, sensors or other devices, such as those further described in relation to FIGS. 9 and 10 or any other suitable software and/or hardware components, or any combination thereof. In some embodiments, the devices of the user, at which the applications may be executed at least in part, comprise user equipment 1007, 1008 and 1010 of FIG. 10. In some embodiments, the control circuitry executes the functions of the applications based on instructions stored in non-transitory memory (e.g., non-transitory memory or storage 908 of FIG. 9, and storage 1017 of server 1004 in FIG. 10). By executing the instructions, input/output (I/O) circuitry and/or the control circuitry translates user inputs, received at the devices, into device actions.

Video media content may be any suitable form of electronic content including at least one video frame when presented via a display device (e.g., television content, streamed content, video-on-demand (VOD) content, advertisements, etc.) and is not limited to numerous types of electronic video games, such as video game content 108. The video media content is provided via any suitable device platform (e.g., via a game console, smartphone application, tablet, desktop, internet, or any other suitable platform, or any suitable combination thereof). In some embodiments, video game content 108 corresponds to either a single player or a multi-player video game. The devices of the user may be, for example, a mobile device such as, for example, a smartphone or tablet. In some embodiments, computing device 104 comprises or corresponds to a computing device connected to a display, such as a gaming console, a laptop computer, a personal computer, a desktop computer, a smart television, a smart watch or wearable device, a stereoscopic display, a wearable camera, extended reality (XR) glasses, XR goggles, a near-eye display device, or any other suitable type of user equipment or computing device connected to a display device, or any combination thereof.

In some embodiments, a user may desire to further interact with a presentation of video media content, besides simply viewing it. Additionally, it may be advantageous for a user to be enabled to capture and interact with content from the world at large or from another screen that is not associated with the user (e.g., an electronic billboard) and without being authenticated with the service that is providing the content. By enabling a user to capture a presentation of video media content containing identifying information, the user may “replay” the video media content by playing the video media content on the user's personal device, resuming from the point captured by the user.

In the example of FIG. 1, video game content 108 is generated for display or presented via device 104. In some embodiments, the video game content 108 and/or device 104 is not associated with the user. In some embodiments, video game content 108 is provided by a gaming console. In some embodiments, video game content 108 is presented as a part of a livestream of the video game provided by a content streaming platform. In some embodiments, video game content 108 is streamed to a gaming console and/or a display device by a cloud gaming server providing the content.

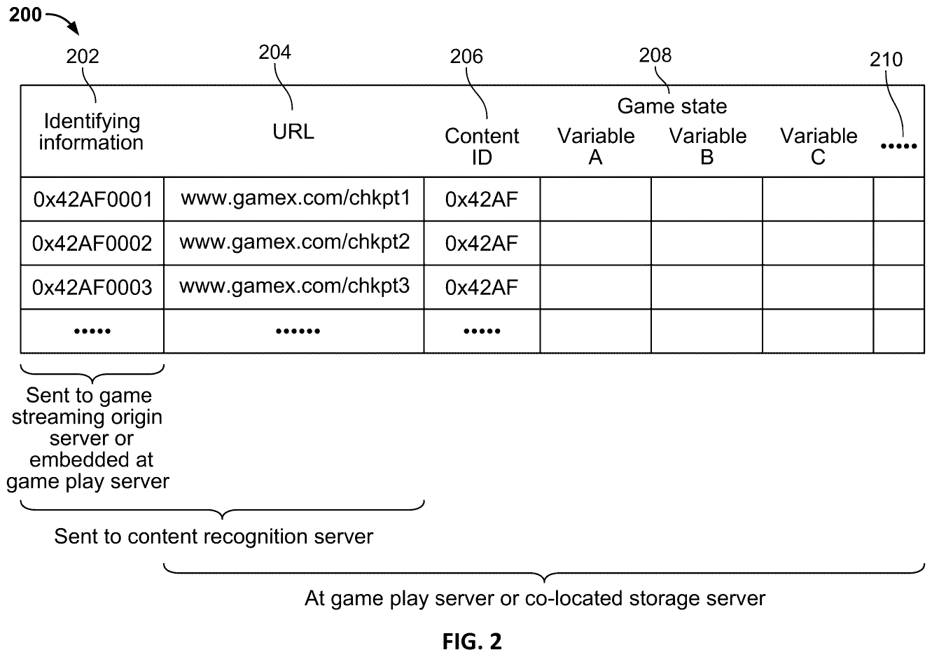

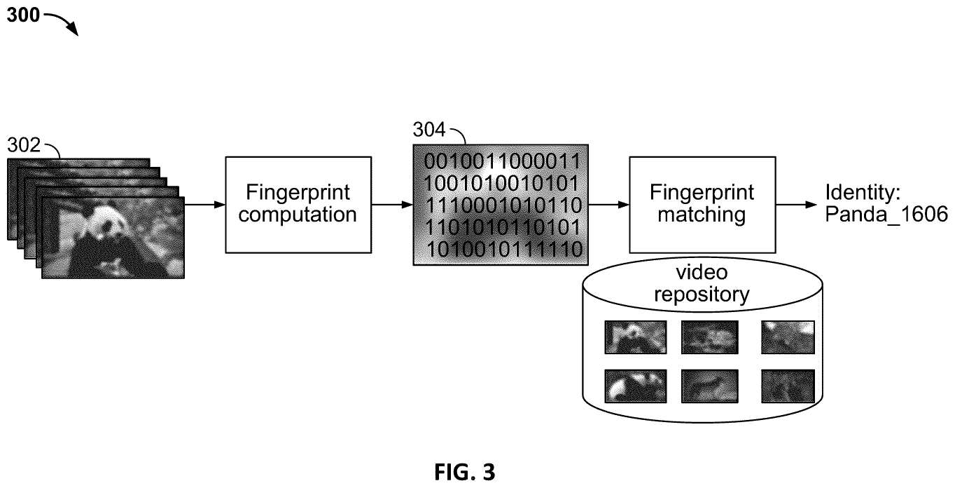

In some embodiments, the presentation of video game content 108 is associated with identifying information that describes the video game content, such as identifying information 114. In some embodiments, the identifying information includes a content identification (ID) and one or more game states of the video game content being presented. In some embodiments, identifying information 114 includes a digital fingerprint using a perceptual hash, for example. In some embodiments, the digital fingerprint is computed on the user's device based on the predictable video frame(s) associated with the presentation of video game content 108 (e.g., based on the predictable video frame(s) captured by the device 106). In some embodiments, identifying information 114 is a digital watermark that is inserted/embedded into the video game content 108 prior to its release from a content server and presentation to the user. Additional description regarding the generation of digital fingerprints and watermarks is found below, particularly with reference to FIGS. 2-3.

In the illustrated embodiment of FIG. 1, a user (e.g., user 102) is watching a presentation of video game content 108 via device 104. In some embodiments, device 106 (e.g., a mobile device) is associated with user 102 and includes a camera. In some embodiments, user 102 uses the camera of device 106 to capture at least a portion of the presentation of video game content 108 being displayed on device 104. For example, a user may hold a camera device up to a livestream of a video game presented on a smart TV and record the presentation of the video game. In some embodiments, device 106 uses edge detection (and/or another image analysis technique) to crop, scale and align the portion of device 104 corresponding to the presentation of video game content 108. While FIG. 1 depicts a series of devices, it should be appreciated that a single device may generate the video media content for display while simultaneously cropping the portion of the display corresponding to the presentation of the content without the use of a camera device. For example, a user may be watching a livestream of a video game on a mobile device, which may be capable of detecting video frames of the livestream within its display. Additionally, in some embodiments, the device presenting video game content 108 (e.g., device 104) may be the same device that is used to capture the livestream. For example, the device 104 may perform a screen capture, and/or other image analysis of the presented content 108.

In some embodiments, device 106 captures the presentation of video game content 108 and sends captured content 110 back to content recognition server 116, thereby shifting the compute load back to a cloud resource associated with content recognition server 116. For example, content recognition server 116 may receive the stream and extract the identifying information (e.g., a watermark) from the video frames of the stream. In some embodiments, a digital fingerprint is computed and matched to a database of known fingerprints. In some embodiments, content recognition server 116 performs the steps of identifying the content depicted in the stream and serving the content back to the device of the user, whether as a video or an interactive experience (e.g., jumping into the captured video game session).

In some embodiments, captured content 110 is analyzed to identify a plurality of video frames (e.g., video frames 112) associated with the presentation of video game content 108. In some embodiments, video frames 112 are associated with identifying information 114, which includes a content ID and a game state corresponding to video game content 108 when it was captured. For example, a user may use their personal device to capture a video clip of video game content generated for display, and the video clip comprises at least one frame containing the identifying information. In some embodiments, the identifying information corresponds to a reference point in the livestream of the video game content, and the reference point includes the content ID and current game state of the video game. In some embodiments, device 106 transmits identifying information 114 to content recognition server 116, which determines the content ID and a game state corresponding to the presentation of video game content 108 in video frames 112. In some embodiments, the content ID is used to identify the particular video game being depicted in the presentation of video game content 108 via device 104. While FIG. 1 provides an example where more than one video frame is analyzed to determine the identifying information, it should be appreciated that a single video frame may be used to determine the identifying information if the single frame is sufficiently detailed to indicate the content ID and game state of the depicted video game.

In some embodiments, the game state of video game content 108 is a set of variable values that are needed to recreate the video game from its most recent state. For example, if video game content 108 is a RPG video game, variable values contributing to the game state of the video game at a particular time may include a most recent checkpoint in the video game, an indication of progress in the video game, and data related to one or more players participating in the video game, among other suitable parameters. As another example, if video game content 108 is a multiplayer racing game, variable values contributing to the game state of the video game at a particular time may include the in-game map where the race is taking place, any in-game weather conditions affecting the roads, how many players are participating in the race and difficulty settings (e.g., if the game requires the player to use only manual transmission driving controls). As a further example, if video game content 108 is a sports video game, variable values contributing to the game state of the video game at a particular time may include information related to the field or area where the in-game sporting event is taking place, information related to the players participating in the video game and how much time is left in a match. Still further, if video game content 108 is a puzzle game, variables related to game state may include the state of the puzzle at the time it was captured by a device of the user. Additionally, if video game content 108 is a turn-based strategy video game or an electronic board game, variables related to game state may include how many turns have elapsed, the amount of time remaining and the state of the board or game area at the time its presentation was captured. In some embodiments, underlying random generator states are identified in order to recreate the game state.

In some embodiments, content recognition server 116 (or a game play server) maintains a data structure or lookup table that comprises a mapping of various identifying information, URLs, content IDs and game states. In some embodiments, the data structure is data structure 118. In some embodiments, content recognition server 116 generates a URL at a particular moment in time, which is mapped to the game state, content ID and identifying information of the video game at that moment in time. For example, a content recognition server may generate a user-interactable link comprising the URL (e.g., URL 120). In some embodiments, new game states are subsequently stored in data structure 118, and corresponding URLs are subsequently generated.

In some embodiments, URL 120 encapsulates the game state of video game content 108 at the timepoint that its presentation was captured by device 106. In some embodiments, URL 120 is transmitted by content recognition server 116 and received by device 106 in the form of a user-interactable link. In some embodiments, device 106 may receive a user-interface interaction associated with URL 120. For example, if device 106 comprises a touchscreen display, device 106 may receive a touch input indicating that the user desires to interact with the URL. In some embodiments, after interacting with URL 120, device 106 may generate a prompt requesting user confirmation to cause at least one device of the user (e.g., gaming console 122) to join a video game session matching the content ID associated with the URL. For example, user 102 may be prompted to either jump into the video game session that was captured by device 106 or play the captured video game individually, in a new video game session, from the same or similar game state corresponding to the time that video game content 108 was captured.

In some embodiments, when user 102 responds affirmatively to the prompt, a request is sent to a game play server. In some embodiments, the request comprises URL 120 associated with the content ID and game state of video game content 108. In some embodiments, the request also contains a parameter that indicates whether the user wants to jump into the video game live, or whether the user wants to play the game individually in a new video game session (depending on optionality provided by the cloud gaming server, based on the content ID). In some embodiments, if user 102 responds via the user device (e.g., device 106) that they would like to jump directly into the video game, a game play server may add the user's device to a virtual machine that is currently responsible for simulating and rendering the video game session associated with video game content 108 when it was captured. Alternatively, in some embodiments, if user 102 responds that they would like to play the video game individually from the game state in which the presentation of video game content 108 was captured, a new virtual machine is initiated based on the content ID and game state associated with video game content 108, and user 102 is added to the new virtual machine. In some embodiments, user 102 may then experience the video game associated with the captured presentation of video game content 108.

In some embodiments, a local device, such as a gaming console or gaming PC (e.g., gaming console 122) is used to render a video game (e.g., video game 126, which corresponds to video game content 108). In some embodiments, the game platform associated with video game content 108 maintains and provides the game state to gaming console 122 for rendering. In some embodiments, the local devices (e.g., gaming console 122) are communicatively connected to the game platform through the rendering engine of the local devices. In some embodiments, user 102 is enabled to join the captured video game session on a device other than the device that captured the presentation of video game content 108 (e.g., device 106). In some embodiments, upon receiving a request to join a game session from device 106, the game play server may then identify the user and a list of the user's devices capable of rendering the requested video game (e.g., using stored credentials or cookies associated with the user's devices). In some embodiments, the game play server offers to add user 102 and/or a device associated with the user 102 to the video game session on the device that is registered with the game platform. In some embodiments, the device that captures the presentation of video game content (e.g., device 106) is used to render the requested video game for user interaction. For example, if video game content 108 relates to a mobile video game and device 106 is a mobile device, user 102 may use device 106 to capture the presentation of video game content 108 and subsequently render the related video game for interaction on the same device, because device 106 is capable of rendering the mobile video game.

In some embodiments, if the requested video game is a single-player video game that is streamed to a desktop computer, no virtual machine is used to render the game play of the video game. For example, if the requested video game is a single-player video game, then the use of a virtual machine is not relevant, and the video game is rendered at a local device. In some embodiments, in the case where a video game engine runs within a virtual machine, the game play server determines whether user 102 (or the various devices associated with user 102) is eligible to join the virtual machine that is responsible for rendering the video game session associated with video game content 108 when it was captured. For example, depending on the type of video game and rules applied to a particular game session, several parameters may prevent a user from joining a captured video game session (e.g., a number of players permitted in the video game, room in the gaming server for the user, a subscription level of the user, a user's in-game progress level in the video game and gaming device capabilities, among other suitable parameters).

In some embodiments, video game content 108 corresponds to a single-player video game, and user 102 is not capable of being added to the virtual machine providing the single-player video game, because there is no virtual machine needed to render the video game and the video game is designed to be played by only one player. In some embodiments, gaming console 122 adds user 102 to a new virtual machine for rendering video game 126 for user interaction based on the content ID and game state of video game content 108 when it was captured.

In some embodiments, video game content 108 corresponds to an instanced multiplayer game (e.g., “Call of Duty”), where a finite number of players are placed into a specific server to participate in the in-game match. In some embodiments, the specific server is already full when gaming console 122 attempts to add user 102 to the same virtual machine, and there is not enough room in the server for user 102 to participate. In some embodiments, gaming console 122 adds user 102 to a new virtual machine for rendering video game 126. In some embodiments, user 102 may wait for the server associated with the new virtual machine to fill with participants, or gaming console 122 may fill the server with computer-based participants (e.g., bots).

In some embodiments, video game content 108 corresponds to a video game that requires a paid subscription to interact with one or more portions of the video game. In some embodiments, the game play server performs an authentication check to confirm that user 102 (or the various devices associated with user 102) has the proper credentials for accessing the video game. In some embodiments, if the entire video game is restricted by requiring a subscription, device 106 may generate for display a message indicating that user 102 (or their devices) does not possess valid credentials and user 102 is not added to any virtual machine for rendering the video game. In some embodiments, if the entire video game is restricted by requiring a subscription, gaming console 122 may generate a new virtual machine comprising a temporary, user-interactable preview of the video game (e.g., a demo version of the video game). In some embodiments, if only a portion of the video game is restricted by requiring a subscription, user 102 may be added to a virtual machine based on the in-game content user 102 is authorized to access based on their subscription level.

In some embodiments, the presentation of video game content 108 on device 104 is associated with a livestream of the video game, hosted by a streamer via a game streaming platform. In some embodiments, the game streaming platform provides viewers of the livestream with the ability to subscribe to or “follow” the streamer, which may provide various benefits for the viewers while interacting with the livestream. In some embodiments, user 102 indicates their desire to play the related video game with the streamer by making the request to be added to the same virtual machine providing the streamer's video game session. In some embodiments, gaming console 122 (or the game engine associated with video game 126 that at least in part runs on gaming console 122) may determine whether user 102 is eligible to join the virtual machine for the streamer's video game session by analyzing the personal in-game progress of user 102. For example, to prevent potential spoilers to a user, the user may not be added to a virtual machine rendering a video game session that is far too advanced when compared to the user's personal game session. In some embodiments, gaming console 122 may compare the in-game progress level of user 102 to a threshold in-game progress level based on the in-game progress level of a streamer hosting the livestream of video game content 108. For example, the livestream of video game content 108 may depict the streamer playing the video game in Zone 5, the end-game zone of the video game. In some embodiments, user 102 has only progressed to Zone 2 of their personal game session on their own gaming device, or user 102 may not be skilled enough to participate in the video game with the streamer in the end-game zone. In some embodiments, if user 102 is not eligible to join the same virtual machine as the streamer based on their personal in-game progress level, a new virtual machine will be initiated. In some embodiments, the new virtual machine is associated with the content ID and game state of the streamer video game session of video game content 108 and provides the user with an interactable preview of the video game session of the streamer. For example, the user may preview playing in Zone 5 by playing as a temporary avatar that mirrors the abilities, items and stats of the streamer in the streamer video game session.

In some embodiments, user 102 (e.g., or their associated devices) may be required to own the video game associated with video game content 108 in order to be added to a virtual machine for the video game. For example, upon receiving a request to add user 102 to a virtual machine for a video game session, the game play server may access the account credentials of user 102 to confirm that user 102 is an owner of a copy of the requested video game. In some embodiments, if it is confirmed that user 102 owns a copy of the requested video game, the user is added to a virtual machine for the video game. In some embodiments, if user 102 does not own a copy of the requested video game, upon receiving the request to join a video game session, user 102 may be directed to a store page to purchase the requested video game. In some embodiments, if user 102 does not own a copy of the requested video game, the user is added to a new virtual machine comprising a temporary, user-interactable preview of the video game (e.g., a demo version of the video game).

In some embodiments, the streamer hosting the livestream of video game content 108 may enforce limitations on which viewers of the livestream are allowed to join the same video game session as the streamer. For example, a streamer hosting the livestream of video game content 108 may allow only viewers that subscribe to the streamer or subscribers of a certain subscriber tier to join the same video game session as the streamer. As a further example, the streamer may limit interactions with viewers using the same virtual machine unless the particular viewer requesting access to the virtual machine is a “diamond-level subscriber”. In some embodiments, the streamer hosting the livestream of video game content 108 may require the viewers requesting to join the video game session to be at a certain in-game level (or rank/seniority), possess certain in-game outfits or objects (e.g., such as possessing a specific in-game weapon) or be associated with a specific in-game character class (e.g., damage, tank or healer). For example, if the streamer is a part of an in-game group of individual players that are all damage dealers, the streamer may only allow a requesting viewer to join the video game session if the requesting user is associated with a tank-type or healer-type of in-game character class.

In some embodiments, if user 102 is unable to join the streamer video game, user 102 may be added to a new virtual machine based on the content ID and game state of video game content 108 when it was captured. In some embodiments, user 102 is unable to join the same video game session as the streamer and joins a new virtual machine for the same video game with other viewers of the livestream. For example, if a number of other viewers captured a portion of the livestream of video game content 108 within a threshold time period of user 102 using device 106 to capture the presentation of video game content 108, user 102 may be added to the new virtual machine with the other viewers or the devices associated with the other viewers. In some embodiments, user 102 is added to a queue of viewers requesting to join the same video game session as the streamer. In some embodiments, when a threshold number of viewers has indicated a desire to join the same video game session as the streamer, a new virtual machine is initialized, and the viewers are added to the new virtual machine. In some embodiments, user 102 is added to a virtual machine with other viewers of the livestream who meet a threshold level of skill or in-game progress related to the requested video game (e.g., joining the user with similarly situated viewers of the livestream).

In some embodiments, a video game session is referred to as an “instance” and one or more virtual machine or game engine may manage a collection of users seeking to join the same instance. In some embodiments, a gaming console or other device capable of executing the requested video game may not be aware of the virtual machine providing a gaming instance. In some embodiments, a gaming device generates a video game session based on the portion of the captured stream and information contained in a profile of the user. For example, a gaming device may use a recovered game state from the captured livestream of the video game and local player configuration files (e.g., keymapping, equipment, customization and other suitable parameters) to generate a temporary save file. In some embodiments, the temporary save file is automatically loaded upon requesting startup of the video game by gaming console 122.

In some embodiments, aspects of the video game may be modified before and/or after the user is added to a virtual machine for the video game session, based on the current game state and the content ID of the captured video game. For example, if video game 126 is an RPG video game, an in-game avatar associated with user 102 may be transported to the in-game location that was depicted by at least one frame captured by device 106 during the presentation of video game content 108, an indicator indicating the in-game location depicted by the captured frame(s) may be provided on an in-game map of the video game environment, the in-game avatar of the user may be provided with certain in-game items that were present or being used when video game content 108 was captured and/or an indication of progress level of the current game state of the video game may be provided (e.g., what chapter, quest or latest checkpoint is currently being implemented in the video game session). In some embodiments, if video game 126 is a racing video game, the system may add user 102 to a video game session beginning on the same map with the same type of racing vehicle depicted in captured frames of the presentation of video game content 108. In some embodiments, if video game 126 is an instanced multiplayer video game, the system may add user 102 to a video game session exhibiting the same parameters as when video game content 108 was captured (e.g., map, difficulty, match type, etc.). In some embodiments, if video game 126 is a sports-related video game, user 102 may be added to a video game session where user 102 is placed on the same team or team composition as the team depicted in the captured presentation of video game content 108. In some embodiments, if video game 126 is a puzzle-type of video game, user 102 may be added to a video game session with the same kind of puzzle, where the puzzle is configured in the same way or in the same state it was captured in during the presentation of video game content 108. In some embodiments, if video game 126 is a turn-based strategy video game, user 102 may be added to a video game session at the same turn (e.g., point of progression) exhibited in the presentation of video game content 108 when it was captured and/or in a match that exhibits the same or similar match parameters. In some embodiments, adding the user to the video game session and modifying aspects of the video game based on the captured game state are based on pseudorandom number generator (PRNG) states and the game state variables.

In some embodiments, a plurality of secondary users is enabled to join the same video game session as a first user (e.g., user 102) once the first user has joined the video game session. For example, using a near field communication (NFC) connection, a first user's device providing the video game may transmit a join token containing critical information about the game session (e.g., including the game state, content ID, and a time offset), to a second user's device. In some embodiments, the second user's device receives the critical information and utilizes it to automatically join the same game session at, for example, the most recently recorded checkpoint where the first user is currently playing. Thus, many players may join the same video game session by, for example, simply tapping a mobile device of the secondary user to the first user's device.

In some embodiments, joining a particular video game session across multiple devices is facilitated by using proximity-based communication technologies, such as Bluetooth Low Energy (BLE), Wi-Fi Direct, Wi-Fi Aware, or other suitable technologies. In some embodiments, the first user's device broadcasts a discovery signal within a certain proximity range. In some embodiments, nearby devices that receive this signal respond by transmitting their device identification and a minimal set of metadata, which includes a list of installed applications. In some embodiments, upon receiving these responses, the first user's device confirms whether the responding devices are within the first user's contact list or gaming group by cross-referencing each device ID against a locally stored or server-side list of authorized devices. In some embodiments, the first user's device also queries the responding devices to confirm if the required game is installed by using a lightweight communication protocol where the second device sends back an application package identifier that matches the requested video game.

In some embodiments, if the second user's device meets the eligibility criteria, the first user's device generates a join token, which is a data packet containing the unique identifier for the active game session (e.g., content ID), the current game state (e.g., including player progress) the checkpoint in the game (e.g., time offset), and a cryptographic signature to ensure data integrity. In some embodiments, the join token is transmitted securely to the eligible second user's device using the established BLE or Wi-Fi Direct connection, with encryption protocols such as advanced encryption standard (AES) used to ensure the security of the data during transmission. In some embodiments, upon receiving the join token, the second user's device validates the join token by checking the cryptographic signature and parsing the token to extract the necessary information (e.g., content ID, game state and time offset) and verifies that the game is installed and compatible with the active game session. In some embodiments, if the join token is valid, the device of the second user presents the second user with a prompt to join the video game session. In some embodiments, when the second user responds affirmatively to the prompt, the second user's device launches the game and begins a synchronization process by loading the game state received in the join token, connecting to the game server using the content ID to synchronize with the current session, and ensuring the second user joins the video game at the same point in the video game as the first user.

In some embodiments, users requesting to simultaneously join the same video game session are enabled to select certain sides or teams (e.g., for a multiplayer game) by being physically near each other. For example, by leveraging proximity-based communication technologies, such as Bluetooth Low Energy (BLE) and Wi-Fi Direct, multiple users within a threshold proximity can be detected and coordinated to select a team and enter the video game session.

In some embodiments, when the devices of two or more users are in close physical proximity, each device periodically broadcasts a discovery signal. In some embodiments, another user's device may receive the signal and respond with its device identification and relevant game metadata, including the player's current game team or side preference if already selected. In some embodiments, the devices exchange information to determine if they are eligible to join the same game session based on criteria such as the installed game, membership in the same contact list or gaming group, and whether the users'devices are configured to allow team selection through proximity. In some embodiments, the devices communicate to ensure that all players in proximity select the same team or side within the game. In some embodiments, the team selection is performed automatically based on predefined preferences, or a prompt is generated for display on each device asking the user to confirm their team choice. In some embodiments, the selection process is facilitated by exchanging secure tokens that represent the chosen team and the game session details, including the content ID and any necessary game state information. In some embodiments, these tokens are encrypted to ensure secure communication and prevent tampering.

In some embodiments, after the team selection is synchronized across all devices, a join token is generated that encapsulates the team choice, game session ID, and relevant game state information. The join token is transmitted to the game play server, which uses the information associated with the token to place all the users on the same team within the same game session. In some embodiments, the game play server processes the join token to ensure that all users are assigned to the correct team and that the session is configured to accommodate the group. In some embodiments, the users'devices launch the requested video game and automatically join the designated team within the multiplayer video game session.

FIG. 2 depicts an example data structure configured to store a mapping of game states, URLs and identifying information, in accordance with some embodiments of the disclosure. In some embodiments, the content recognition server maintains a reference table or data structure that comprises a mapping of relationships between content IDs, game states, URLs and identifying information. In some embodiments, the content recognition server maintains data structure 200, which may be the same as data structure 118 of FIG. 1.

In some embodiments, a game streaming origin server is responsible for transcoding and packaging a livestream of video media content. In some embodiments, the game streaming origin server creates identifying information 202 (e.g., a dynamic digital watermark) based on content ID 206 and game state information 208 that is embedded in the content prior to transcoding and packaging. In some embodiments, game state information 208 also indicates variables 210, which describe the game state. In some embodiments, the video media content is provided to one or more content distribution networks for caching and distribution, and identifying information 202 is provided to the content recognition server along with the mapping of content ID 206 and game state information 208 for each piece of identifying information 202.

In some embodiments, a digital watermark is used to “catch and replay” the video media content, instead of a digital fingerprint. For example, identifying information may be inserted/embedded directly into the video media content by a content origin server, prior to the release of the content. In some embodiments, the original content can be unambiguously identified by detecting the digital watermark in a potentially modified version of the watermarked video media content. In some embodiments, the practice of concealing information within another message or physical object to avoid detection may be considered a sub-field/use of steganography. In some embodiments, steganography may be used to hide virtually any type of digital content, including text, image, video, or audio content. In some embodiments, the hidden content is extracted and revealed at its destination.

In some embodiments, a watermark may be generated based on a single frequency plane spread spectrum method (SFPSS) that meets the following requirements: invisibility is required because watermark embedding inevitably causes image degradation; robustness is needed for resistance to noise caused by compression and digital/analog conversions, resistance to geometric distortion or spatial de-synchronization caused by time-variant angle of freehand video shooting, and resistance to temporal shifts or temporal de-synchronization due to the arbitrary timing of video shooting by users; high-speed detection processing (throughput) is needed to enable onboard processing by mobile phones; quick response (short latency) is needed for usability and for the time required for successful detection to be short; and reliable detection is essential to guarantee the quality of service.

In some embodiments, the content origin server generates the digital watermarks using the content ID associated with the video media content and the time offset (e.g., for video content) or the game state (e.g., for video game content) of the content from its beginning, which are embedded in the video frames. In some embodiments, the generated watermarks are “dynamic” because they change based on different game states and time offsets as the video media content progresses. Thus, in some embodiments, the same video media content will be associated with many different watermarks corresponding to different game states or timepoints. In some embodiments, the digital watermark may be extracted when the video media content is captured by the device of the user in any manner as described in relation to FIG. 1.

In some embodiments, the granularity with which a unique game state or timepoint in the video media content is used to create the watermark governs how frequently the watermark changes. For example, if content replay and resumption need to be synchronized to only a few seconds, then the digital watermark does not need to be changed for every video frame/segment/chunk. Similarly, in some embodiments, if the game state of the video media content does not change in any significant way, a new watermark does not need to be created for a game state occurring at a different time period. In that scenario, the same watermark is used to subsequently mark the frames of the content.

In some embodiments, the digital watermark comprises a limited payload size. In some embodiments, the content provider or content origin server uses any suitable techniques to keep the digital watermark payload small. For example, the content origin server may concatenate a few bytes of content ID and a few bytes representing the game state together into one value that is no more than four to eight bytes. In some embodiments, the digital watermark may be split into multiple parts spanning multiple frames of the video media content, and the limitations on the size of the payload for the watermark may be circumvented. In some embodiments, the total size of the data included in the payload contains amounts corresponding to the sum of the size of the data in the fragmented payload. In some embodiments, having less restriction on the size of the digital watermark payload allows the content origin server to include more information in the digital watermark such as a base URL, content ID and content game state, which allows a client device (e.g., device of the user) to generate a request for media directly to the content origin server. In some embodiments, the content origin server also includes an exhibition ID in the watermark, allowing the content origin server to track the provenance of a “catch and replay” request. For example, the same advertisement shown on a TV and on a billboard may have different exhibition IDs.

In some embodiments, two octets (16 bits) are each used to identify the content ID and the game state associated with the captured video media content. In some embodiments, they are appended together to yield a four-byte dynamic digital watermark payload.

In some embodiments, the content recognition server is aware of the rules used to create the identifying information and does not maintain a data structure such as data structure 200. For example, using the known rules used to generate the identifying information, the content recognition server may simply parse the identifying information to determine the content ID and game state. In some embodiments, the content recognition server is aware of the rules used to create the identifying information based on a priori knowledge possessed by the application, or knowledge provided by another entity such as a content distribution network (CDN) that received the rules from an origin server. In some embodiments, the identifying information is a digital watermark, and the content recognition server does not need to perform a translation of the digital watermark in order to determine the content ID and game state.

In some embodiments, data structure 200 also includes a mapping between URLs 204 (which are created to correspond to the game state of a presentation of video media content at a specific time), identifying information 202, content ID 206 and game state information 208. In some embodiments, as the presentation of the video media content progresses, data structure 200 may be modified to include a reference to new game states based on the progression. New corresponding URLs are subsequently generated and associated with each new game state. In some embodiments, periodically updating data structure 200 with new game states and corresponding URLs allows a user to “catch and replay” the video media content from any captured point in the presentation of the video media content. In some embodiments, a new URL may be generated every second, every few seconds, every minute, or at any other suitable regular or irregular interval. Further, in some embodiments, a new URL may be generated based on threshold changes in the game state (e.g., each time a checkpoint is reached, each time an objective is completed, or based on the occurrence of one or more other in-game events).

FIG. 3 depicts an illustrative process of computing a fingerprint, which may include an identification of a video game (e.g., a content ID), in accordance with some embodiments of the disclosure. In some embodiments, video fingerprinting process 300 is used to identify video media content, such as video media content 302 (which may be the same as, e.g., video game content 108 of FIG. 1). In some embodiments, the previously described identifying information (e.g., identifying information 114 of FIG. 1 and identifying information 202 of FIG. 2) includes a digital fingerprint used for identifying captured video media content (e.g., “catch and replay” video media content). In some embodiments, video fingerprinting is referred to as content-based copy detection or near-duplicate detection using a perceptual hash. In some embodiments, perceptual hashes are similar to standard checksums, however, instead of comparing hashes to establish exact matches between files at the bit level, the perceptual hashes establish similarity of content as would be perceived by a viewer or listener.

In some embodiments, the predictable frames of video media content 302 are analyzed to generate a compact representation (e.g., fingerprint) that uniquely identifies the video media content. For example, video media content 302 is processed to extract distinctive features, such as keyframes, colors, shapes, motion patterns, or other suitable identifying features. In some embodiments, the processing can account for changes such as blurring, compression/resolution scaling, etc. Thus, in some embodiments, the video fingerprinting process 300 is effective even when a duplicate copy of the content is significantly degraded or modified from the original. In some embodiments, in the case of video game media content, the digital fingerprint identifies only the content ID of the video game, but for other programmable content, fingerprinting or watermarking techniques may be used to “catch and replay” content.

In some embodiments, fine granularity fingerprints in the time domain are implemented to determine a time offset of the video media content from its beginning so that it can be played on a second screen from the same point at which it was observed by the viewer's personal device on the first screen. In some embodiments, the time offset is described as a time elapsed since beginning of the content or a frame number or any other parameter that indicates the timepoint t=T of the content given that the beginning of the content is time t=0. In some embodiments, video fingerprinting process 300 is performed at the user device (e.g., device 106 of FIG. 1) that captures video media content 302. For example, a mobile device of the user may capture a presentation of video media content 302 and process the captured frames to determine a fingerprint, such as fingerprint 304. In some embodiments, fingerprint 304 includes the content ID of video media content 302 at the time it was captured. In some embodiments, fingerprint 304 is transmitted to a content recognition server, which returns the content ID to the user's device.

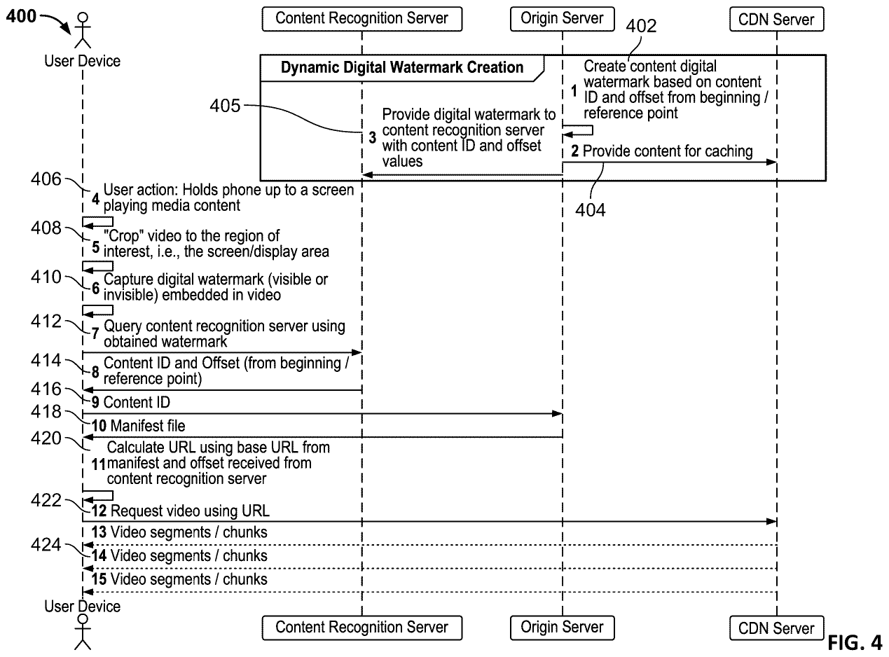

FIG. 4 depicts a flow diagram of an example process for enabling a device of a user to capture video media content using identifying information, in accordance with some embodiments of the disclosure. In some embodiments, the identifying information is identifying information 114, as described in relation to FIG. 1, and comprises a digital watermark.

In some embodiments, at step 402 of process 400, a content origin server creates digital watermarks using the content ID and the time offset of the video media content from the beginning of the video media content, which are embedded into the video frames of the content. In some embodiments, the time offset of the video media content includes the game state of the video media content. At step 404, the content origin server provides the video media content (with the embedded watermarks) to a content distribution network (CDN) server for caching. In some embodiments, at step 405, the content distribution network also provides the content recognition server with the watermarks along with reference information about the content ID and its game states. In some embodiments, this information is stored in a data structure, such as data structure 118 of FIG. 1 or data structure 200 of FIG. 2.

In some embodiments, at step 406, a user holds their personal device up to a display screen displaying the video media content received from the CDN server. In some embodiments, at step 408, the display area presenting the video media content is cropped and the digital watermark is identified (e.g., using image analysis). At step 410, the digital watermark embedded in the video media content is “captured.” Capturing the watermark may refer to the process of using any suitable image analysis of the captured video media content to extract the watermark. In some embodiments, the user device captures the video media content in any manner as described in relation to FIG. 1. In some embodiments, at step 412, the digital watermark payload is sent to the content recognition server as a query, and a response contains the content ID associated with the video media content. In some embodiments, at step 414, the device of the user receives the content ID associated with the video media content. In some embodiments, at step 416, the content ID associated with the video media content is provided to the content origin server, and a manifest file corresponding to the video media content is received at step 418. In some embodiments, the device of the user queries the content origin server for the manifest file associated with the video media content. In some embodiments, after receiving the manifest file, the user's personal device performs a translation, using the received time offset, to derive a segment or chunk number to request. In some embodiments, the user's personal device then calculates a new URL using the base URL received from the manifest and the segment/chunk to be requested. In some embodiments, the user's personal device initiates an HTTP request and begins streaming the video media content from the particular segment/chunk.

At step 420, the device of the user calculates the URL to begin fetching the video media content using the game state information (e.g., included in the time offset). In some embodiments, at step 422, the device of the user provides the calculated URL to the CDN server to request playback of the video media content. In some embodiments, at step 424, the CDN server provides the video media content to the device of the user, and the device of the user receives the video media content in the form of video frames, video segments or chunks for playback.

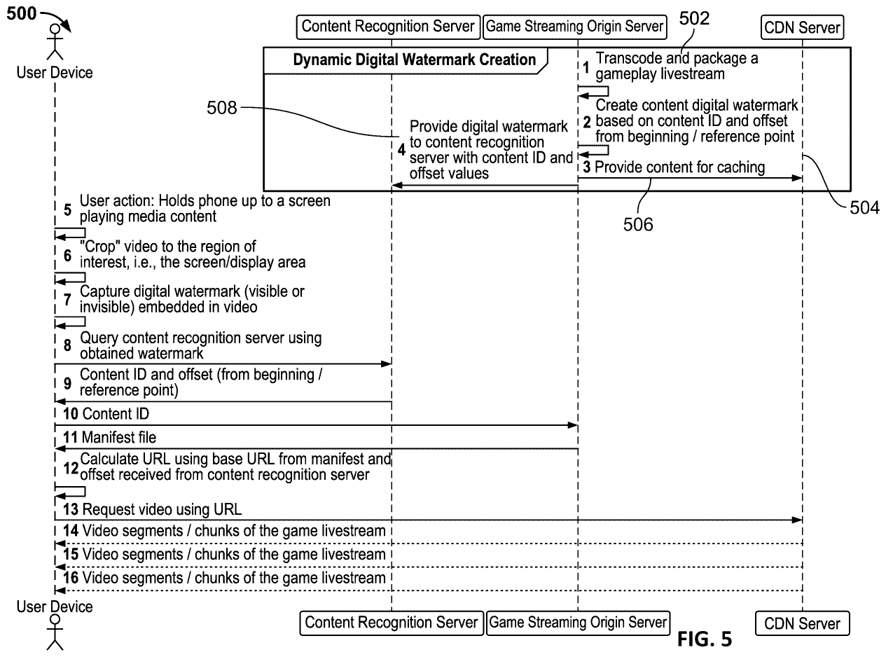

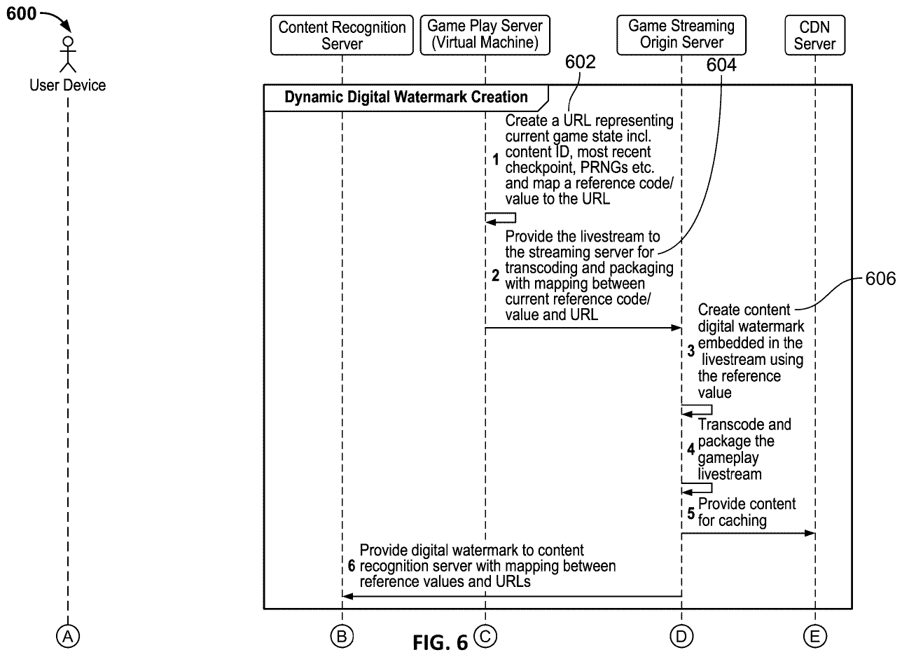

FIG. 5 depicts a flow diagram of an example process of enabling a device of a user to capture a livestream presentation of video game content using identifying information, in accordance with some embodiments of the disclosure. In some embodiments, the identifying information is identifying information 114, as described in relation to FIG. 1, and comprises a digital watermark. In some embodiments, the video media content is a livestream of a video game.

In some embodiments, process 500 begins with step 502, where a game streaming origin server transcodes and packages the livestream media content. In some embodiments, the livestream media content is any other video media content previously described. In some embodiments, the livestream media content is received from a gamer by the game streaming origin server. In some embodiments, at step 504, the game streaming origin server creates a “dynamic” digital watermark based on the content ID and the time offset from t=0 that is embedded in the livestream media content prior to transcoding and packaging. In some embodiments, the game streaming origin server performs step 504 based on the content ID and the game state of the video game depicted in the livestream media content. In some embodiments, at step 506, the livestream media content is provided to one or more CDN servers for caching. At step 508, the digital watermark is provided to the content recognition server with a mapping between the content ID and game state for each watermark payload. In some embodiments, this information is stored in a data structure by the content recognition server, such as data structure 118 of FIG. 1 or data structure 200 of FIG. 2. In some embodiments, the remaining steps of process 500 are the same as steps 406-424 as described in relation to FIG. 4. In some embodiments, chunks of the livestream media content are provided to the user, such that the livestream media content may be played back at a device of the user.

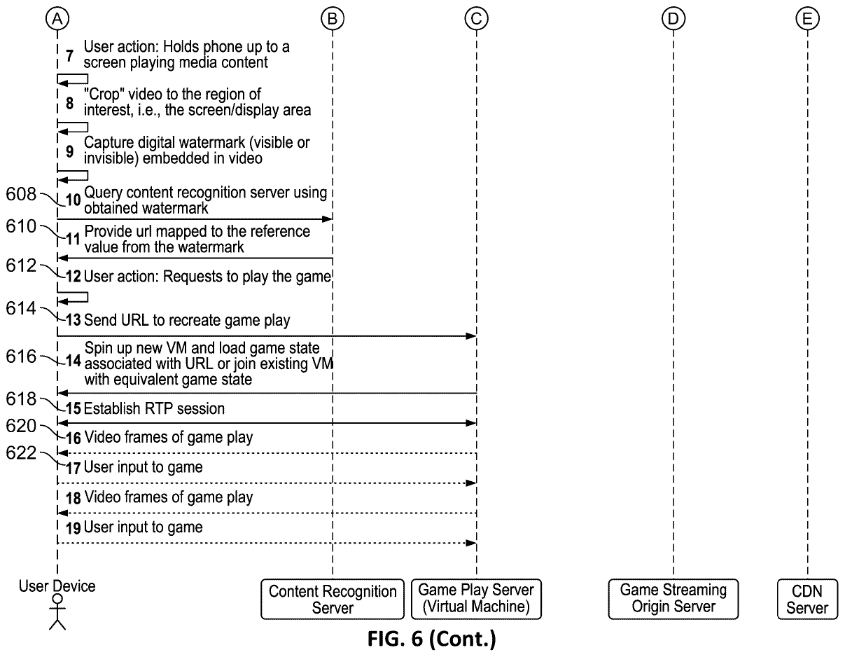

In some embodiments, the video game content is provided to the user via a cloud gaming session. For example, a game engine may provide the video game content to the user based on game data provided to the game engine identified by the content recognition server. In some embodiments, the content ID and time offset of the livestream may be sufficient to derive a game state of the captured video game session. However, in some embodiments, the game streaming origin server is not the same as the game play server and additional techniques are required, as described in relation to FIG. 6.

FIG. 6 depicts a flow diagram of an example process of enabling a device of a user to capture a livestream presentation of video game content and to join a video game session via a device of the user, in accordance with some embodiments of the disclosure. In some embodiments, the identifying information is identifying information 114, as described in relation to FIG. 1, and comprises a digital watermark. In some embodiments, the video media content is a livestream of a video game and is video game content 108 of FIG. 1. In some embodiments, using the below techniques, a viewer of a livestream of a video game may jump into an interactive experience associated with the depicted video game. In some embodiments, a user can insert themselves as a player/character in the same video game session that is depicted in the livestream, or the user could play the game individually, starting at the captured state of the video game.

In some embodiments, process 600 begins at step 602, where a game play server (e.g., a server that runs the game simulation and renders the video frames) creates a dynamic digital watermark as a reference code/value, which is mapped to a URL by the content recognition server. In some embodiments, the URL itself is mapped to the game state depicted in the captured video game content, which is a set of variable values that are needed to, for example, recreate the video game from its most recent checkpoint. In some embodiments, the variables attributing to the game state of the video game are any of the game state variables further described in relation to FIG. 1. In some embodiments, the game state includes the content ID, a most recent checkpoint and/or any global pseudo-random numbers (e.g., seeds) generated by PRNGs that will be useful in recreating the state of the video game, player data or other suitable video game aspects.

In some embodiments, at step 604, the game play server provides the livestream of the video game content to a game streaming origin server that is responsible for transcoding and packaging the livestream. In some embodiments, the game play server also provides the game streaming origin server with the reference code/value (the digital watermark payload) to be embedded into the video game content. In some embodiments, the game play server inserts the digital watermark into the video game content prior to providing the video frames to the content origin server for processing. In some embodiments, the game play server also provides a reference table (that is dynamically updated) to the content recognition server that contains the mapping between the digital watermark (code/value) and the associated URL that it has created to capture the game state of the video game content at a particular timepoint. In some embodiments, the URL is generated by the content recognition server based on the extracted watermark.

In some embodiments, at step 606, the game streaming origin server transcodes and packages the livestream of the video game content and provides it to the CDN server. In some embodiments, the user subsequently captures the digital watermark embedded in the livestream of the video game content in any manner as previously described in relation to FIG. 1 or 4. In some embodiments, at step 608, the digital watermark is transmitted to the content recognition server as a query, and the response from the content recognition server contains the URL that encapsulates the game state of the livestream of the video game content at a particular timepoint. In some embodiments, at step 610, the device of the user receives the URL. In some embodiments, at step 612 and in response to a prompt provided to the user to join a video game session for the video game content depicted in the livestream, the user makes a request to play the related video game. In some embodiments, at step 614, the request is provided to the game play server with the URL that comprehensively describes the game state of the video game content depicted in the livestream at the time it was captured by the device of the user.

In some embodiments, at step 616 and in response to receiving the user request to join a video game session for the depicted video game, the game play server either identifies the existing virtual machine responsible for rendering the video game session depicted in the livestream or determines a new virtual machine that may be loaded based on the content ID and game state indicated in the received URL. In some embodiments, at step 618, the game play server establishes a game session between the game play server and the device of the user that is capable of executing the requested video game. In some embodiments, the game session is based on a real-time transport protocol (RTP) session. In some embodiments, at step 620, the user is added to a virtual machine for a video game session corresponding to the video game session depicted in the livestream of the video game content and video frames of the video game are generated at the device of the user. In some embodiments, the user is added to a virtual machine for the video game in any manner as previously described in relation to FIG. 1. In some embodiments, at step 622, the game play server receives user-interface inputs interacting with the video game via the device of the user. Thus, an interactive experience between the user viewing the livestream of the video game content and the related video game is achieved.

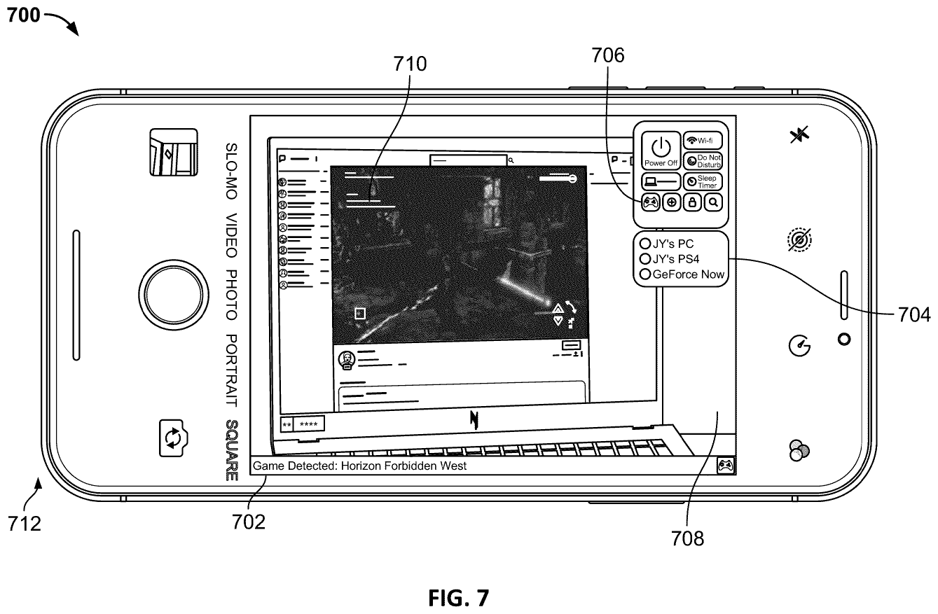

FIG. 7 depicts an example user interface embodiment for enabling a device of a user to capture a livestream presentation of video game content and to join a video game session via a device of the user, in accordance with some embodiments of the disclosure. In some embodiments, user interface 700 depicts a live capture of a device of a user (e.g., a laptop computer) displaying a presentation of video media content. In some embodiments, the video media content is video game content, such as video game content 710, which may be the same as video game content 108 of FIG. 1. In some embodiments, a user utilizes user device 712 to capture the presentation of the video media content. In some embodiments, user device 712 is the same as device 106 of FIG. 1. In some embodiments, images 708 captured by device 712 are the same images as content 108 of FIG. 1, displayed on device 104 of FIG. 1.

As described in relation to FIGS. 1 and 4-6, a user may attempt to capture the presentation of video media content by holding user device 712 up to the presentation of the video media content, such that the presentation of the video media content via the device of the user is displayed within viewfinder preview 708 of a camera application associated with user device 712. In some embodiments, the user desires to capture a presentation of video media content so that the user may continue watching the content from a different device. In some embodiments, the user desires to capture a presentation of video media content so that the user may continue watching a saved version of the content at a different time. In some embodiments, the user desires to capture a presentation of video media content so that the user may join the virtual machine that is currently rendering the content. In some embodiments, the user desires to capture a presentation of video media content so that the user may join a different virtual machine for a similar video game session based on the parameters used to establish the current video game session displayed by the device of the user.

Continuing the example where the video media content displayed by the device of the user is video game content 710, user device 712 may detect that a presentation of a video game is being displayed. For example, by positioning user device 712 such that the presentation of the video media content via the device of the user is displayed within viewfinder preview 708, user device 712 displays message 702 describing that a specific video game has been detected in viewfinder preview 708. In some embodiments, user device 712 identifies the name of the video game (e.g., “Horizon Forbidden West”) and any other relevant information related to the presentation of video game content 710 via the device of the user, which is included in message 702.

In some embodiments, once user device 712 affirmatively detects the presentation of video game content 710, user interface 700 is modified to include a widget (e.g., widget 706) for enabling the user to join a video game session. In some embodiments, widget 706 is included in user interface 700 prior to the detection of video game content 710, but the widget is greyed or blacked out and remains in an inactive state until video game content 710 is detected. In some embodiments, while widget 706 remains in an inactive state, it is not available to receive user-interface inputs via user interface 700. In some embodiments, widget 706 functions as a “join now” control element, which allows the user to join the game they watch at the moment they are watching. In some embodiments, a game platform attaches the same kind of data it generates to enable the “catch and play” feature from a video capture of a game session to the control element (e.g., widget 706).

In some embodiments, a user indicates their desire to join a video game session, related to the presentation of video game content 710, by interacting with widget 706. For example, user interface 700 may receive a user-interface input for the user. In some embodiments, if user device 712 (e.g., the capturing device) comprises a touch screen display, the user-interface input may be a touch input received by user interface 700. In some embodiments, upon receiving a user-interface input interacting with widget 706, user interface 700 is modified to display a list of user devices 704. In some embodiments, list of user devices 704 is automatically generated for display without user device 712 receiving the user-interface input with widget 706. In some embodiments, list of user devices 704 comprises a listing of the available user devices that are capable of executing instructions to run the video game and/or rendering video frames of the requested video game. In some embodiments, list of user devices 704 also includes an identification of a user's cloud gaming subscriptions, where cloud gaming capabilities/techniques are used to render the video game as a video game stream via capable devices of the user. In some embodiments, list of user devices 704 identifies suitable user devices based on their hardware capabilities. In some embodiments, nearby user devices are identified because they are a part of the same local Wi-Fi network. In some embodiments, nearby user devices are identified because they are already registered to play the video game with the user. For example, list of user devices 704 is able to identify the user's PC (or other display device which is currently generating the presentation of video game content 710, but may also be used to play the depicted video game), the user's Playstation™ 4(PS4 ) (e.g., a gaming console) and the user's subscription to GeForce Now™ (e.g., a cloud gaming service).

In some embodiments, user interface 700 may receive a user-interface input indicating a user's selection of a particular device in list of user devices 704. In some embodiments, the selected device from list of user devices 704 is the device that attempts to add the user to a video game session related to the presentation of video game content 710. In some embodiments, upon receiving a selection of a device from list of user devices 704, the selected device is automatically activated and attempts to add the user to a video game session. In some embodiments, the selected device adds the user to a virtual machine for a video game session in any manner as described in relation to FIGS. 1 and 4-6.

In some embodiments, user interface 700 also displays additional widgets (e.g., or other user-selectable options) to allow the user to join a video game session with other users by using the NFC and BLE/Wi-Fi techniques described in relation to FIG. 1.

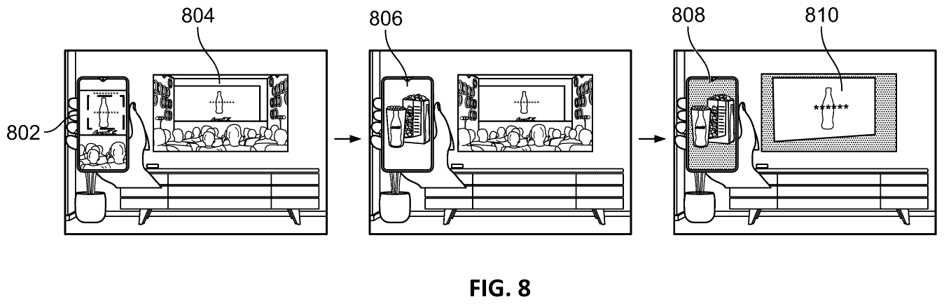

FIG. 8 depicts an example embodiment of modifying the presentation of video media content on the devices of the user once cross-device playback is initiated, in accordance with some embodiments of the disclosure. In some embodiments, once cross-device playback has been initiated, the original device displaying the video media content (e.g., first device 804) may switch to displaying different video media content meant to supplement the video media content being displayed on a secondary device (e.g., second device 802). In some embodiments, second device 802 is the device that captures the presentation of video media content displayed via first device 804 and may be device 106 of FIG. 1. In some embodiments, first device 804 is device 104 of FIG. 1. In some embodiments, second device 802 may resume playback of the main video media content initially displayed via first device 804, and first device 804 may show supplemental content. In both cases, the time offset value is extracted from the presentation of the video media content on first device 804 and is used to synchronize the presented video media content.

For example, a user may be sitting in a movie theater and the theater screen (e.g., first device 804) displays a Coke™ ad. Using this example, once cross-device playback is established and while the Coke™ ad is displayed via the theater screen, a user's smartphone (e.g., second device 802) may show an ice-cold drink in the theater seat's cupholder as supplemental content (e.g., shown by display 806). In some embodiments, once playback across both devices synchronizes, media events, such as the lights going down in the Coke™ commercial, occur concurrently on both presentations of the content on the TV (e.g., first device 804) and the user's smartphone (second device 802). For example, as shown by respective displays 808 and 810, when the background of the display 810 begins to darken to emphasize the advertisement, the presentation of the supplemental content via display 808 is darkened in a similar manner.

In some embodiments, the above techniques are applied to an advertisement (e.g., for a mobile video game). For example, an advertisement for a smartphone video game may be shown via a TV screen (e.g., first device 804), which depicts a sample level from the video game. In some embodiments, a user may use the smartphone device (e.g., second device 802) to capture the presentation of the advertisement for the smartphone video game. Upon initiating cross-device playback, in some embodiments, the user's smartphone (e.g., second device 802) may render the smartphone video game for display and enable the user to begin playing the advertised video game at the advertised level. Using this example, the TV screen (e.g., first device 804) may show additional background features for the video game the user is playing (e.g., supplemental content), such an extension of the levels or a view of another level in the video game.

FIG. 9 depicts illustrative devices and systems for capturing and interacting with a presentation of video media content, in accordance with some embodiments of the disclosure.

FIG. 9 shows generalized embodiments of illustrative user equipment 900 and 901. For example, user equipment 900 may be a smartphone device, a laptop, a tablet, a near-eye display device, an XR device, or any other suitable device. In another example, user equipment 901 may be a user television equipment system or device. User equipment 901 may include set-top box 916. Set-top box 916 may be communicatively connected to microphone 917, audio output equipment (e.g., speaker or headphones 914), and display 912. In some embodiments, microphone 917 may receive audio corresponding to a voice of a video conference participant and/or ambient audio data during a video conference. In some embodiments, display 912 may be a television display or a computer display. In some embodiments, set-top box 916 may be communicatively connected to user input interface 910. In some embodiments, user input interface 910 may be a remote-control device. In some embodiments, user input interface 910 also comprises I/O circuitry. Set-top box 916 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 10. In some embodiments, device 900 may comprise any suitable number of sensors (e.g., gyroscope or gyrometer, or accelerometer, etc.), and/or a GPS module (e.g., in communication with one or more servers and/or cell towers and/or satellites) to ascertain a location of device 900. In some embodiments, device 900 comprises a rechargeable battery that is configured to provide power to the components of the device.

Each one of user equipment 900 and user equipment 901 may receive content and data via input/output (I/O) path 902. I/O path 902 may provide content (e.g., broadcast programming, on-demand programming, internet content, content available over a local area network (LAN) or wide area network (WAN), and/or other content) and data to control circuitry 904, which may comprise processing circuitry and storage 908. Control circuitry 904 may be used to send and receive commands, requests, and other suitable data using I/O path 902, which may comprise I/O circuitry. I/O path 902 may connect control circuitry 904 (and specifically the processing circuitry) to one or more communications paths (described below). I/O functions may be provided by one or more of these communications paths, but are shown as a single path in FIG. 9 to avoid overcomplicating the drawing. While set-top box 916 is shown in FIG. 9 for illustration, any suitable computing device having processing circuitry, control circuitry, and storage may be used in accordance with the present disclosure. For example, set-top box 916 may be replaced by, or complemented by, a personal computer (e.g., a notebook, a laptop, a desktop), a smartphone (e.g., device 900), an XR device, a tablet, a network-based server hosting a user-accessible client device, a non-user-owned device, any other suitable device, or any combination thereof.

Control circuitry 904 may be based on any suitable control circuitry such as processing circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 904 executes instructions for the media application stored in memory (e.g., storage 908). Specifically, control circuitry 904 may be instructed by the media application to perform the functions discussed above and below. In some implementations, processing or actions performed by control circuitry 904 may be based on instructions received from the media application.

In client/server-based embodiments, control circuitry 904 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 9, the instructions may be stored in storage 908, and executed by control circuitry 904 of a device 900.

In some embodiments, the media application may be a client/server application where only the client application resides on device 900, and a server application resides on an external server (e.g., server 1004 and/or media content source 1002). For example, the media application may be implemented partially as a client application on control circuitry 904 of device 900 and partially on server 1004 as a server application running on control circuitry 1011. Server 1004 may be a part of a local area network with one or more of devices 900, 901 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 1004 and/or an edge computing device), referred to as “the cloud.” Device 900 may be a cloud client that relies on the cloud computing capabilities from server 1004 to generate personalized engagement options in a VR environment. The client application may instruct control circuitry 904 to generate personalized engagement options in a VR environment.

Control circuitry 904 may include communications circuitry suitable for communicating with a server, edge computing systems and devices, a table or database server, or other networks or servers. The instructions for carrying out the above-mentioned functionality may be stored on a server (which is described in more detail in connection with FIG. 10). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 10). In addition, communications circuitry may include circuitry that enables peer-to-peer communication of user equipment, or communication of user equipment in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as media application data described above. Nonvolatile memory may also be used (e.g., to launch a boot-up routine and other instructions). Cloud-based storage, described in relation to FIG. 9, may be used to supplement storage 908 or instead of storage 908.

Control circuitry 904 may receive instruction from a user by way of user input interface 910. User input interface 910 may be any suitable user interface, such as a remote control, mouse, trackball, keypad, keyboard, touch screen, touchpad, stylus input, joystick, voice recognition interface, or other user input interfaces. Display 912 may be provided as a stand-alone device or integrated with other elements of each one of user equipment 900 and user equipment 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to set-top box 916.

Audio output equipment 914 may be integrated with or combined with display 912.

Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of device 900 and device 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 917 or audio output equipment 914 may include a microphone configured to receive audio input such as voice commands or speech. For example, a user may speak letters or words that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card.

The media application may be implemented using any suitable architecture. For example, it may be a stand-alone application wholly implemented on each one of user equipment 900 and user equipment 901. In such an approach, instructions of the application may be stored locally (e.g., in storage 908), and data for use by the application is downloaded on a periodic basis (e.g., from an out-of-band feed, from an internet resource, or using another suitable approach). Control circuitry 904 may retrieve instructions of the application from storage 908 and process the instructions to provide video conferencing functionality and generate any of the displays discussed herein. Based on the processed instructions, control circuitry 904 may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, participation data from a conference participant profile. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the media application is a client/server-based application. Data for use by a thick or thin client implemented on each one of user equipment 900 and user equipment 901 may be retrieved on-demand by issuing requests to a server remote to each one of user equipment 900 and user equipment 901. For example, the remote server may store the instructions for the application in a storage device. The remote server may process the stored instructions using circuitry (e.g., control circuitry 904) and generate the displays discussed above and below. The client device may receive the displays generated by the remote server and may display the content of the displays locally on device 900. This way, the processing of the instructions is performed remotely by the server while the resulting displays (e.g., that may include text, a keyboard, or other visuals) are provided locally on device 900. Device 900 may receive inputs from the user via input interface 910 and transmit those inputs to the remote server for processing and generating the corresponding displays. For example, device 900 may transmit a communication to the remote server indicating that an up/down button was selected via input interface 910. The remote server may process instructions in accordance with that input and generate a display of the application corresponding to the input (e.g., a display that moves a cursor up/down). The generated display is then transmitted to device 900 for presentation to the user.

In some embodiments, the media application may be downloaded and interpreted or otherwise run by an interpreter or virtual machine (run by control circuitry 904). In some embodiments, the media application may be encoded in the ETV Binary Interchange Format (EBIF), received by control circuitry 904 as part of a suitable feed, and interpreted by a user agent running on control circuitry 904. For example, the media application may be an EBIF application. In some embodiments, the media application may be defined by a series of JAVA-based files that are received and run by a local virtual machine or other suitable middleware executed by control circuitry 904. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

FIG. 10 depicts devices and systems including a server, a communication network, and computing devices for performing the methods and processes noted herein, in accordance with some embodiments of the disclosure.

As shown in FIG. 10, user equipment 1007, 1008 and 1010 may be coupled to communication network 1009. Communication network 1009 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1009) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths, but are shown as a single path in FIG. 10 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 1009.

System 1000 may comprise media content source 1002, one or more servers 1004, database 1005, and/or one or more edge computing devices. In some embodiments, the media application may be executed at one or more of control circuitry 1011 of server 1004 (and/or control circuitry of user equipment 1007, 1008, 1010 and/or control circuitry of one or more edge computing devices). In some embodiments, the media content source and/or server 1004 may be configured to host or otherwise facilitate video communication sessions between user equipment 1007, 1008, 1010 and/or any other suitable user equipment, and/or host or otherwise be in communication (e.g., over network 1009) with one or more social network services.

In some embodiments, server 1004 may include control circuitry 1011 and storage 1017 (e.g., RAM, ROM, Hard Disk, Removable Disk, etc.). Storage 1017 may store one or more databases. Server 1004 may also include an I/O path 1012. I/O path 1012 may provide video conferencing data, device information, or other data, over a local area network (LAN) or wide area network (WAN), and/or other content and data to control circuitry 1011, which may include processing circuitry, and storage 1017. Control circuitry 1011 may be used to send and receive commands, requests, and other suitable data using I/O path 1012, which may comprise I/O circuitry. I/O path 1012 may connect control circuitry 1011 (and specifically control circuitry) to one or more communications paths.

Control circuitry 1011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1011 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1011 executes instructions for an emulation system application stored in memory (e.g., the storage 1017). Memory may be an electronic storage device provided as storage 1017 that is part of control circuitry 1011.

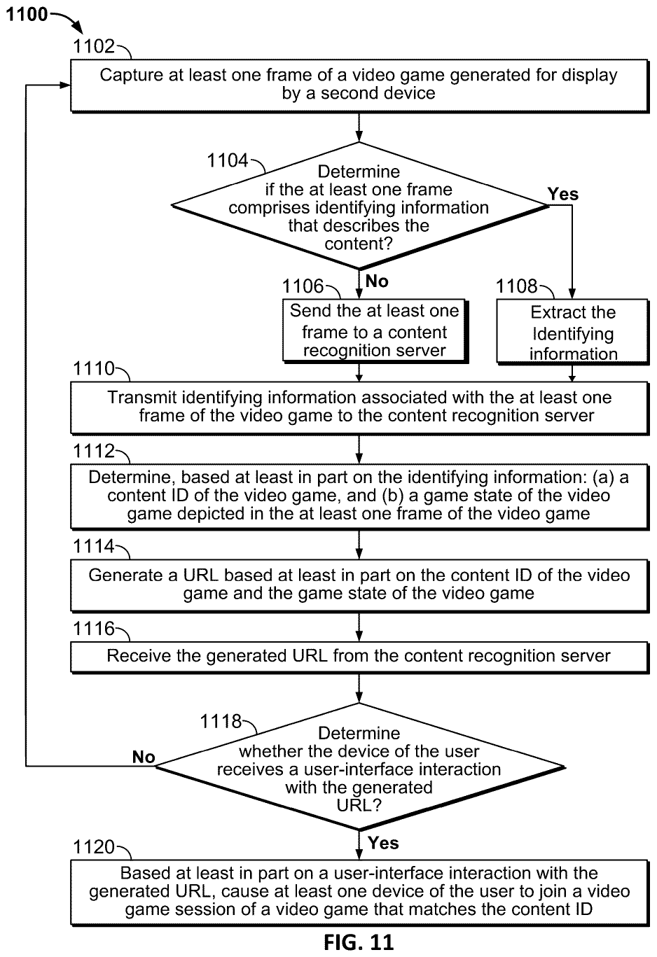

FIG. 11 is a flowchart of the process capturing a presentation of video media content and enabling the user to interact with the video media content, in accordance with some embodiments of the disclosure. In various embodiments, the individual steps of process 1100 may be implemented by one or more components of the devices, techniques, and software of FIGS. 1-10. Although the present disclosure may describe certain steps of process 1100 (and of other processes described herein) as being implemented by certain components of the devices and software of FIGS. 1-10, this is for purposes of illustration only, and it should be understood that other components of the devices and systems of FIGS. 1-10 may implement those steps instead.

Process 1100 begins at step 1102, where control circuitry (e.g., control circuitry 904 or 1011 of FIGS. 9 and 10, respectively) of a first device captures at least one frame of a video game generated for display by a second device. In some embodiments, the first device captures a presentation of video media content (e.g., described in relation to FIGS. 1-8), which can be video game content. In some embodiments, the user captures the presentation of the video game by holding the first device up to the presentation and using a camera application of the first device to capture at least a portion of the presentation of video game content. In some embodiments, the first device captures the presentation of video game content in any manner as previously described in relation to FIGS. 1-8.

At step 1104, it is determined whether the captured frames of the video game content are associated with identifying information that describes the content, which may be a digital watermark or may include a digital fingerprint. In some embodiments, a watermark is embedded in the video game content prior to release as described in relation to FIGS. 1-6. In some embodiments, if the captured frames of the video game content are not associated with identifying information, step 1104 may proceed to step 1106, where the first device that captures the presentation of the video game content sends the captured frames of the video game to a content recognition server to be analyzed. In some embodiments, if the captured frames of the video game content are associated with the identifying information, step 1104 may proceed to step 1108, where the first device that captures the presentation of the video game content extracts the identifying information. In some embodiments, extracting the identifying information associated with the captured frames of the video game includes extracting a digital watermark from the captured frames.

In some embodiments, once the digital fingerprint has been computed or the digital watermark has been extracted, process 1100 proceeds to step 1110, where the identifying information (e.g., a digital watermark) is transmitted to a content recognition server. In some embodiments, at step 1112, the content recognition server processes the identifying information to determine a content ID that describes the video game content being displayed and a game state that describes the various parameters influencing the video game content as it is presented. In some embodiments, the game state is determined based on a plurality of variables that describe the game state, as described in relation to FIGS. 1-3. In some embodiments, the content recognition server maintains a data structure that comprises a mapping of relationships between a plurality of URLs, game states, content ID and identifying information. In some embodiments, the data structure is the same as data structure 118 or data structure 200 of FIGS. 1-2, respectively.

In some embodiments, at step 1114, the content recognition server generates a URL based at least in part on the content ID of the video game and the game state of the video game at the time its presentation was captured with the first device. At step 1116, the generated URL is provided to the first device by the content recognition server.

In some embodiments, at step 1118, the first device of the user monitors for a user-interface interaction with generated URL. In some embodiments, if the first device does not receive a user-interface interaction with the generated URL within a threshold period of time of receiving the URL, the first device determines that the user does not desire to interact with the captured video game. In some embodiments, if the first device does not receive a user-interface interaction with the generated URL, process 1100 proceeds back to step 1102, where the first device is enabled to perform a second capturing event of the presented video game content.

In some embodiments, if the first device receives a user-interface interaction with the generated URL, process 1100 proceeds to step 1120, where at least one device of the user is caused to join a video game session of the video game that matches the content ID. In some embodiments, the at least one device of the user joins a video game session based on the game state of the video game content at the time its presentation was captured. In some embodiments, the at least one device of the user is added to a virtual machine for the video game session in any manner as described in relation to FIGS. 1-6.

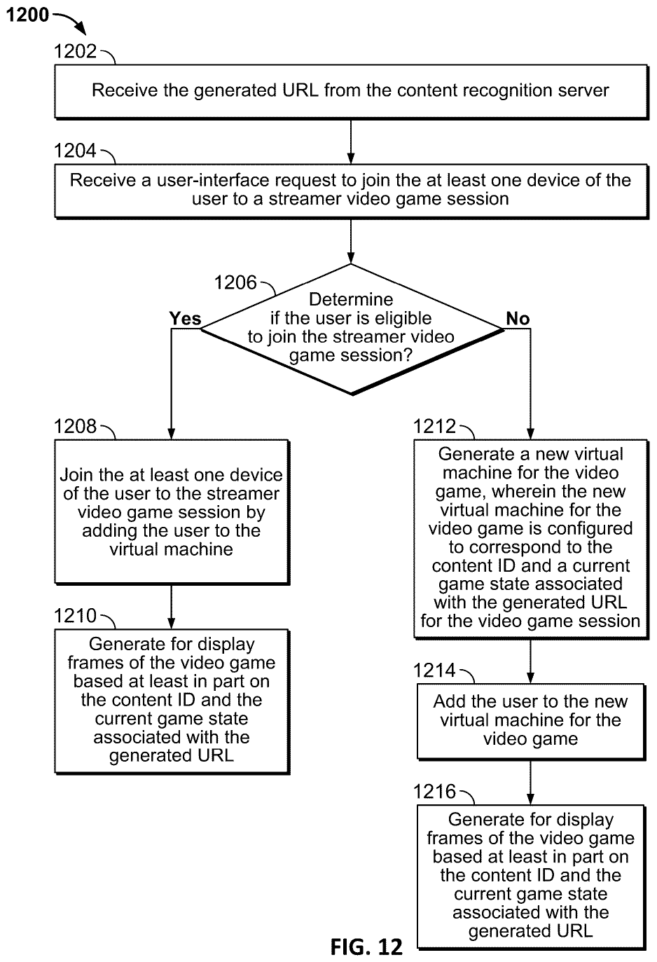

FIG. 12 is a flowchart of the process for adding a user to a virtual machine to join a video game session, in accordance with some embodiments of the disclosure. In various embodiments, the individual steps of process 1200 may be implemented by one or more components of the devices, techniques, and software of FIGS. 1-11. Although the present disclosure may describe certain steps of process 1200 (and of other processes described herein) as being implemented by certain components of the devices and software of FIGS. 1-11, this is for purposes of illustration only, and it should be understood that other components of the devices and systems of FIGS. 1-11 may implement those steps instead.

Process 1200 begins at step 1202, where control circuitry (e.g., control circuitry 904 or 1011 of FIGS. 9 and 10, respectively) of a device of the user receives the generated URL from the content recognition server. In some embodiments, the URL is generated in any manner as described in relation to FIGS. 1-6. In some embodiments, the URL is generated based on a presentation of video media content (e.g., described in relation to FIGS. 1-8) via a device of the user, which can be video game content. In some embodiments, the presentation of video media content is a livestream of video game content hosted by a streamer via a video game streaming platform. In some embodiments, at step 1204, the device of the user that receives the URL receives a user-interface request to join at least one device of the user to a streamer video game session. In some embodiments, the user interface is based on a user-interface interaction with the received URL. In some embodiments, the request to join the streamer video game session is transmitted to a game play server that is responsible for maintaining a plurality of virtual machines for video games.

In some embodiments, at step 1206, the game play server determines whether the user is eligible to be added to the virtual machine that is currently rendering the video game depicted in the livestream (e.g., to join the streamer's video game session). In some embodiments, determining whether the user is eligible to be added to the virtual machine includes analyzing a user's subscription status, a user's personal in-game progress level, whether there is room in the session for the user and the capabilities of the user devices, among other suitable characteristics described in relation to FIG. 1. In some embodiments, if the game play server determines that the user is eligible to be added to the virtual machine that is currently rendering the video game depicted in the livestream, process 1200 may proceed to step 1208, where at least one device of the user joins the streamer video game session by adding the user to the virtual machine. In some embodiments, a user is added to a virtual machine for a video game session in any manner as described in relation to FIGS. 1-6.

In some embodiments, once the device of the user joins the streamer video game session, at step 1210, the device of the user rendering the video game generates frames of the video game for display based on the content ID for the video game and the game state of the video game at the time its presentation was captured.

In some embodiments, at step 1206, if the game play server determines that the user is not eligible to be added to the virtual machine for the streamer video game session, process 1200 proceeds to step 1212, where a new virtual machine for the video game is generated by the game play server. In some embodiments, the new virtual machine is configured to correspond to the content ID and a current game state associated with the generated URL for the video game session. In some embodiments, the new virtual machine is configured in any manner as described in relation to FIGS. 1-6 and may include a temporary, user-interactable preview of the streamer's video game session from the perspective of the streamer. In some embodiments, at step 1214, the user is added to the new virtual machine for the video game, and the user may interact with the video game in a new video game session. At step 1216, the device of the user that joins the new virtual machine generates frames of the video game for display based on the content ID for the video game and the game state of the video game at the time its presentation was captured.

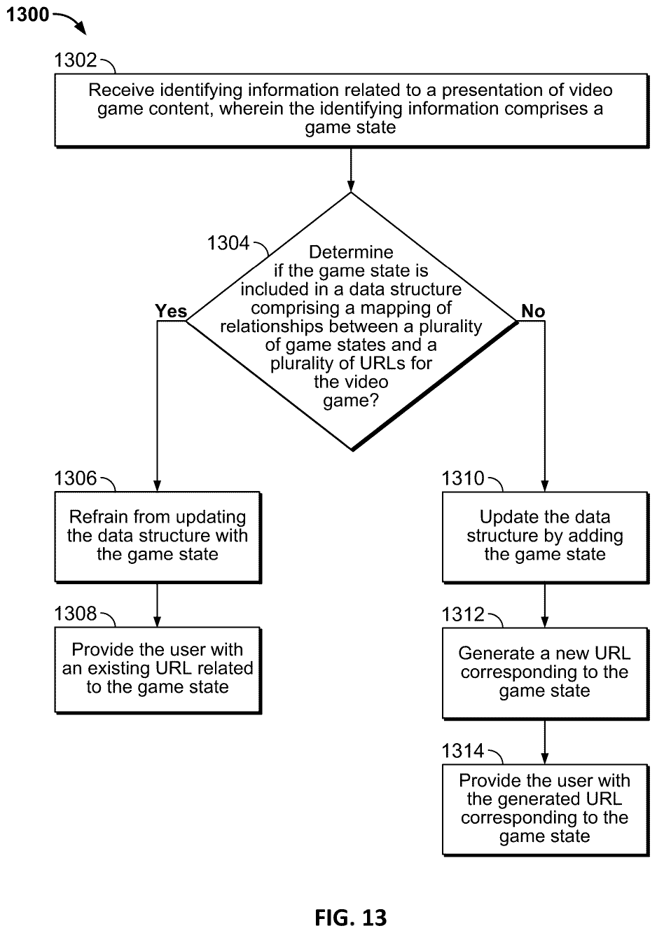

FIG. 13 is a flowchart of the process updating a data structure comprising a mapping of relationships between a plurality of game states and a plurality of URLs for the video game, in accordance with some embodiments of the disclosure. In various embodiments, the individual steps of process 1300 may be implemented by one or more components of the devices, techniques, and software of FIGS. 1-12. Although the present disclosure may describe certain steps of process 1300 (and of other processes described herein) as being implemented by certain components of the devices and software of FIGS. 1-12, this is for purposes of illustration only, and it should be understood that other components of the devices and systems of FIGS. 1-12 may implement those steps instead.

Process 1300 begins at step 1302, where control circuitry (e.g., control circuitry 904 or 1011 of FIGS. 9 and 10, respectively) of a content recognition server receives identifying information related to a presentation of video media content (e.g., described in relation to FIGS. 1-8) captured by a device of a user. In some embodiments, the video media content is video game content. In some embodiments, the identifying information includes a content ID and game state that describes the state of the video game content at the time its presentation was captured. In some embodiments, the identifying information is in the form of a digital watermark or may include a digital fingerprint, which may be configured in any manner as described in relation to FIGS. 1-6.

In some embodiments, at step 1304, the content recognition server determines if the game state associated with the received identifying information is already included in a data structure comprising a mapping of relationships between a plurality of game states, a plurality of URLs, content ID and identifying information for the video game being presented. In some embodiments, the content recognition server determines if the game state is included in the data structure by comparing a difference in game state variables that describe various game states, respectively. For example, the content recognition server may compare the variables associated with the game state of the received identifying information with the variables associated with game states that are already stored in the data structure. In some embodiments, the content recognition server maintains the data structure, and the data structure is the same as data structure 118 or data structure 200 of FIGS. 1-2, respectively.

In some embodiments, if the game state associated with the received identifying information is already included in a data structure, process 1300 proceeds to step 1306, where the content server refrains from updating the data structure with the game state included in the received identifying information. For example, the content recognition server may determine that difference between game states does not meet or exceed a threshold difference in game states and thus, it is determined that at least one game state already stored in the data structure is sufficiently similar to the game state associated with the received identifying information. In some embodiments, the content recognition server may determine whether the game state associated with the received identifying information was received within a threshold time period of receiving a previous game state. In some embodiments, if the game state associated with the received identifying information was received within the threshold time period, the content recognition server may determine that the received game state is not different enough from the previously stored game state and thus should not be added to the data structure. In some embodiments, at step 1308, the content recognition server provides a device of the user with an existing URL that corresponds to a game state already stored in the data structure.

In some embodiments, at step 1304, the content recognition server determines that the game state associated with the received identifying information is not included in the data structure, and process 1300 proceeds to step 1310. At step 1310, the content recognition server updates the data structure by adding a new entry corresponding to the game state associated with the received identifying information. In some embodiments, the data structure is updated in any manner as described in relation to FIGS. 1-6. In some embodiments, once the data structure is updated with the new entry for the received game state, process 1300 proceeds to step 1312. At step 1312, a new URL is generated based on the content ID and game state associated with the received identifying information. In some embodiments, at step 1314, the newly generated URL is provided to the device of the user. In some embodiments, the device of the user may receive a user-interface interaction with the newly generated URL (e.g., in any manner as described in relation to FIGS. 1-6) indicating the user's desire to participate in an interactive experience with the captured video game content.

While FIGS. 11-13 provide separate examples of various embodiments, it should be appreciated that one or more of the steps of these examples may be considered in combination.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
capturing, by a camera of a first device associated with a user, at least one frame of a video game generated for display by a second device;
transmitting, by the first device to a content recognition server, the at least one frame of the video game, wherein the content recognition server is configured to:
extract identifying information from the at least one frame of the video game;
determine, based at least in part on the identifying information: (a) a content ID of the video game, and (b) a game state of the video game depicted in the at least one frame of the video game; and
generate a URL based at least in part on the content ID of the video game and the game state of the video game;
receiving the generated URL from the content recognition server; and
based at least in part on a user-interface interaction with the generated URL, causing at least one device of the user to join a video game session of a video game that matches the content ID, wherein the video game session is configured based at least in part on the game state of the video game.

2. The method of claim 1, wherein the identifying information is at least one watermark extracted from the at least one frame of the video game.

3. The method of claim 2, wherein the at least one watermark is the generated URL, and wherein at least a portion of the generated URL indicates a corresponding game state stored by the content recognition server.

4. The method of claim 1, wherein the identifying information is at least one fingerprint computed based on the at least one frame of the video game or a perceptual hash establishing a similarity of the video game perceived by the user.

5. The method of claim 1, wherein the capturing comprises capturing a video clip of the video game generated for display, wherein the video clip comprises the at least one frame, the method further comprising:
computing a plurality of fingerprints for each frame of the video clip, respectively.

6. The method of claim 1, wherein the game state is determined by analyzing the identifying information respectively associated with a plurality of frames.

7. The method of claim 1, wherein the identifying information is added to the at least one frame of the video game by a game streaming origin server providing the video game.

8. The method of claim 7, wherein the game streaming origin server is configured to generate the identifying information for a livestream of the video game, wherein the identifying information corresponds to a reference point in the livestream, and wherein the reference point comprises the content ID and a current game state of the video game, the method further comprising:
transmitting the identifying information to the content recognition server;
providing, via the first device, first identifying information to the content recognition server, wherein the first identifying information corresponds to the at least one frame of the video game captured by the first device; and
receiving, at the first device, the content ID and the current game state corresponding to the first identifying information.

9. The method of claim 1, further comprising:
computing, by the first device, the identifying information based at least in part on the at least one frame of the video game.

10. The method of claim 1, wherein the video game session is depicted in a livestream of a streamer video game session and is provided by a virtual machine, wherein the virtual machine is associated with a plurality of game states respectively represented by a plurality of URLs for the streamer video game session, wherein each URL of the plurality of URLs for the streamer video game session comprises the content ID and a current game state of the streamer video game session, wherein each URL of the plurality of URLs for the streamer video game session corresponds to the identifying information for the livestream, wherein the generated URL comprises a first URL of the plurality of URLs for the streamer video game session, and wherein causing the at least one device of the user to join the video game session comprises:
joining the at least one device of the user to the streamer video game session by adding the user to the virtual machine; and
generating for display, via the at least one device of the user, frames of the video game based at least in part on the content ID and the current game state associated with the generated URL.

11. The method of claim 1, wherein causing the at least one device of the user to join the video game session comprises:
generating, at a game play server, a new virtual machine for the video game, wherein the new virtual machine for the video game is configured to correspond to the content ID and a current game state associated with the generated URL for the video game session; and
adding the user to the new virtual machine for the video game.

12. The method of claim 11, wherein adding the user to the new virtual machine for the video game comprises:
adding the user to the new virtual machine along with at least one other device associated with at least one other user that interacted with the generated URL.

13. The method of claim 1, wherein:
a game play server maintains a data structure comprising a mapping of relationships between a plurality of game states and a plurality of URLs for the video game;
the plurality of URLs for the video game comprises the generated URL;
the game play server periodically stores new game states in the data structure as game play of the video game progresses;
the data structure is shared with the content recognition server; and
the content recognition server provides the generated URL to the user in response to receiving the user-interface interaction.

14. The method of claim 1, wherein the game state of the video game comprises at least one of: a most recent checkpoint in the video game, an indication of progress in the video game, and data related to one or more players participating in the video game.

15. The method of claim 1, wherein the causing the at least one device of the user to join the video game session comprises:
based at least in part on a current game state and the content ID of a virtual machine providing the video game session, causing the at least one device of the user to perform at least one of:
transporting an in-game avatar of the user to an in-game location depicted by the at least one frame captured by the first device;
providing an indicator on an in-game map of the video game, wherein the indicator indicates the in-game location;
providing the in-game avatar of the user with in-game items; and
providing an indication of a progression level of the current game state of the video game.

16. The method of claim 1, wherein the video game is depicted in a livestream, the method further comprising:
determining a threshold in-game progress level based on an in-game progress level of a streamer hosting the livestream of the video game; and
based at least in part on determining that an in-game progress level of the user does not meet or exceed the threshold in-game progress level:
refraining from adding the user to a virtual machine associated with a video game session of the streamer; and
generating a new virtual machine, wherein the new virtual machine comprises a user-interactable preview of the video game session of the streamer.

17. The method of claim 1, further comprising:
generating for display on the first device, a list of devices of the user that are capable of executing the video game session, wherein the list of devices comprises the at least one device of the user; and
receiving a user-interface selection of a selected device from the list of devices,
wherein the user-interface interaction with the generated URL causes the selected device to join the video game session.

18. A system comprising:
a game streaming origin server, wherein the game streaming origin server is configured to:
identify a portion of a livestream of a video game;
generate a digital watermark based at least in part on a content ID and a game state of the portion of the livestream of the video game; and
modify the portion of the livestream of the video game to include the digital watermark; and
transmit the digital watermark to a content recognition server; and
a content recognition server configured to:
store the digital watermark; and
wherein the game streaming origin server is further configured to:
provide the modified portion of the livestream of the video game to a user device.

19. The system of claim 18, wherein the content recognition server is further configured to:
receive, from the user device, a query comprising a captured digital watermark;
determine that the captured digital watermark matches the stored digital watermark; and
provide the content ID and the game state to the user device.

20. A system comprising:
a memory;
a control circuitry; and
an input/output (I/O) circuitry configured to:
capture, by a camera of a first device associated with a user, at least one frame of a video game generated for display by a second device;
transmit, by the first device to a content recognition server, the at least one frame of the video game,
wherein the content recognition server is configured to:
extract identifying information from the at least one frame of the video game;
wherein the control circuitry is configured to:
determine, based at least in part on the identifying information: (a) a content ID of the video game, and (b) a game state of the video game depicted in the at least one frame of the video game; and
wherein the content recognition server is further configured to:
generate a URL based at least in part on the content ID of the video game and the game state of the video game, wherein the generated URL is stored in the memory; and
wherein the I/O circuitry is further configured to:
receive the generated URL from the content recognition server; and
based at least in part on a user-interface interaction with the generated URL, cause at least one device of the user to join a video game session of a video game that matches the content ID, wherein the video game session is configured based at least in part on the game state of the video game.

21-93. (canceled)
